(19) United States
(12) Patent Application Publication
(10) Pub. No.: US 2002/0004472 A1
(43) Pub. Date: Jan. 10, 2002

(54) Compression process for multiphase tablets

(76) Inventors: Thomas Holderbaum, Monheim (DE); Bernd Richter, Leichlingen (DE); Christian Nitsch, Duesseldorf (DE); Markus Semrau, Timmaspe (DE); Rolf Bayersdoerfer, Landau (DE)

Correspondence Address: CONNOLLY BOVE LODGE & HUTZ LLP, P.O. Box 2207, Wilmington, DE, 19899, US

(21) Appl. No.: 09/737,661

(22) Filed: Dec. 15, 2000

(30) Foreign Application Priority Data
Dec. 17, 1999 (DE) 199 61 367.2

(51) Int. Cl. C11D 1/00

(52) U.S. Cl. 510/290

(57) ABSTRACT

A compression process is provided for producing multiphase tablets, especially laundry detergent or cleaning product tablets, which comprises the steps of

a) producing core tablets comprising active substance,

b) optionally inserting one or more core tablets from step a) into a die of a tableting press,

c) filling at least one particulate premix into the die of the tableting press,

d) supplying at least one core tablet from step a) into the die of the tableting press,

e) optional single or multiple repetition of steps c) and/or d),

f) carrying out compression to give tablets, it being possible, if desired, to conduct steps c) and d) in the opposite order, and in at least one of process steps b), c), d) or f) the upper and/or lower punch of the tableting press having a nonplanar pressing face.

The present invention relates to a novel process for producing tablets, especially laundry detergent and cleaning product tablets.

Laundry detergent and cleaning product tablets have been widely described in the prior art and are enjoying increasing popularity among users owing to the ease of dosing. Tableted cleaning products have a number of advantages over their powder-form counterparts: they are easier to dose and to handle, and have storage and transport advantages owing to their compact structure. Consequently, there exists an extremely broad prior art relating to laundry detergent and cleaning product tablets, which is also reflected in an extensive patent literature. At an early stage, the developers of products in table form hit upon the idea of using tablet regions of different composition to release certain ingredients only under defined conditions in the course of washing or cleaning, in order to improve the end result. Tablets which have become established in this context are not only the core/sheath tablets and ring/core tablets, which are sufficiently well known from pharmacy, but also, in particular, multilayer tablets, which are nowadays available for many segments of washing and cleaning or of hygiene. Visual differentiation of the products is also becoming increasingly important, so that single-phase and single-color tablets in the field of washing and cleaning have been largely displaced by multiphase tablets. Common current market forms include two-layer tablets having a white and colored phase or having two differently colored layers. In addition, there exist inlay tablets, ring-core tablets, laminated tablets, etc., whose importance at present is fairly minor.

Multiphase toilet cleaning tablets are described, for example, in EP 055 100 (Jeyes Group). This document discloses toilet cleaning product blocks comprising a shaped body, consisting of a slow-dissolving cleaning product composition, into which a bleach tablet has been embedded. At the same time, this document discloses a very wide variety of design forms of multiphase tablets. In accordance with the teaching of this document, the tablets are produced either by inserting a compressed bleach tablet into a mold and casting the cleaning product composition around this tablet, or by casting part of the cleaning product composition into the mold, followed by the insertion of the compressed bleach tablet and, possibly, subsequent overcasting with further cleaning product composition.

In addition, EP 481 547 (Unilever) describes multiphase cleaning product tablets which are intended for use for machine dishwashing. These tablets have the form of core/sheath tablets and are produced by stepwise compression of the constituents: first of all, a bleach composition is compressed to form a tablet, which is placed in a die which is half-filled with a polymer composition, this die then being filled up with further polymer composition which is compressed to form a bleach tablet provided with a polymer sheath. The process is subsequently repeated with an alkaline cleaning product composition, so as to give a three-phase tablet.

Another route to producing visually differentiated laundry detergent and cleaning product tablets is described in International Patent Applications WO99/06522, WO99/27063 and WO99/27067 (Procter & Gamble). According to the teaching of these documents, a tablet is produced which has a cavity that is filled with a solidifying melt. Alternatively, a powder is introduced and is fixed in the cavity by means of a coating layer. A common feature of all three applications is that the region filling out the cavity should not be compressed, since the intention is to deal gently in this way with pressure-sensitive ingredients.

The route described in the prior art of preparing melts into which tablets are inserted or which are cast into tablets involves a thermal load on the ingredients in the melts. In addition, the precise metering of media liquid to pastelike in consistency, and the subsequent cooling, necessitate great technical effort, which depending on the composition of the melt is in some cases destroyed by shrinkage on cooling and the detachment of the filling that this causes. The filling of cavities with powder-form ingredients, and fixing by means of coating, is likewise complex and hampered by similar stability problems. Furthermore, it is not possible with either process to realize deliberately controlled, different hardness of the individual tablet regions.

If precompressed core tablets are added to tabletable premixes, the regions lying above and below these cores, respectively, will be compressed to a greater extent during the subsequent tableting operation, which may lead to instances of retarded solubility. If the solubility of these overcompressed regions is to be compensated by a lower pressing pressure overall, there may be inadequate compression of the tablet regions above and below which there are no core tablets, leading to unwanted reduced handling stability.

The conventional tableting of multilayer tablets likewise reaches its limits in the field of laundry detergent and cleaning product tablets if one layer is intended to comprise only a small fraction of the total tablet. Below a certain layer thickness, compression of a layer adhering to the remainder of the tablet becomes increasingly difficult.

The production of core-sheath tablets or so-called bulleye tablets, occasionally employed in the pharmaceutical sector, cannot be adapted without problems to the production of large tablets, since problems occur with the placing of the cores. A core which is not precisely inserted centrally, however, greatly disrupts the visual impression of the tablet. The requirements regarding the accurate location of cores therefore increase exponentially with the surface area of the tablets.

The impression of particulate compositions into cavities of tablets, although solving the problem of the temperature exposure of these fillings, may also lead to retarded dissolution of this pressed part, so necessitating the addition of dissolution accelerants if temporally accelerated release of the ingredients from this region is called for.

It is an object of the present invention, then, to provide tablets in which both temperature-sensitive and pressure-sensitive ingredients may be inserted in delimited regions, without any restrictions on the size of the delimited region(s) in relation to the overall tablet. At the same time, moreover, there firstly ought to be visual differentiation from conventional two-layer tablets, and secondly the production of the tablets ought to function reliably without great technical effort and even in mass production without the tablets suffering from stability drawbacks and without the fear of dosing inaccuracies. The process to be provided should not only minimize the problem of the overcompression of the regions lying above and below inserted core tablets but should also have very great flexibility. In particular, the intention was to permit the production of tablets comprising faster-dissolving and/or slower-dissolving regions, in conjunction with a high level of visual differentiation from conventional tablets.

It has now been found that the abovementioned objects are achieved if precompressed tablets are supplied to a tableting press and are compressed to multiphase tablets together with a premix metered into the die, where punches with a nonplanar surface come into contact with the material for tableting at at least one place in the tableting machine.

The invention provides a process for producing multiphase laundry detergent or cleaning product tablets, which comprises the steps of

a) producing core tablets comprising active substance,

b) optionally inserting one or more core tablets from step a) into a die of a tableting press,

c) filling at least one particulate premix into the die of the tableting press,

d) supplying at least one core tablet from step a) into the die of the tableting press,

e) optionally repeating steps c) and/or d) one or more times,

f) carrying out compression to give tablets, it being possible, if desired, to conduct steps c) and d) in the opposite order, and in at least one of process steps b), c), d) or f) the upper and/or lower punch of the tableting press has a nonplanar pressing face.

In the first step of the process of the invention, a tablet is produced which subsequently—together with particulate premix—is compressed to give a multiphase tablet. The process of the invention also permits the compression of two or more core tablets together with one or more particulate premixes, virtually unlimited possibilities being created both by the variability of formulation and by the visual differentiation of the resultant tablets.

The process of the invention is described in greater detail below. In the context of the present invention, the term “core tablet” refers to a tablet which can be supplied purposively to the process of the invention. This core tablet differs from the particulate premix firstly by its greater spatial extent in comparison to the individual particles of the premix and secondly by virtue of the fact that its placing into the die of the tableting press is carried out not randomly (i.e., in a loose bed, like the particulate premix) but in a defined and ordered motion.

In the context of the present invention, the term “base tablet” refers to all regions of the end products of the process of the invention that are not core tablets, i.e., all regions obtained by compressing particulate premixes.

The term “planar” pressing face characterizes all faces which have no significant elevations and/or depressions, “significant” elevations being those in the order of magnitude range up to 500 μm. “Nonplanar” pressing faces, therefore, are pressing faces from which (an) elevation(s) protrude/protrudes and/or into which (a) depression(s) protrude/protrudes which is/are higher or deeper, respectively, than 500 μm.

In the context of the present invention, pressing faces which have an all-round elevation for the purpose of giving the tablets for production a “chamfered” (beveled) edge are planar since the pressure-exerting face is planar. In addition, the known use of commercially customary punch inserts made from polymers such as Vulkollan®, which are bonded adhesively to the pressing faces, leaves the pressure-exerting faces planar, so that this type of punch furnishing is likewise planar in the sense of the present invention.

The process as claimed in claim 1, wherein the upper punch and/or lower punch of the tableting press does not have a nonplanar pressing face during the entire process.

The process as claimed in claim 2, wherein the punch used as upper and/or lower punch is constructed of a plurality of component punches which are movable independently of one another and parallel with respect to one another.

In this embodiment of the process of the invention, each component punch of the upper and/or lower punch, of course, requires its own punch track, in order to ensure mutually independent movability of the component punches. In the context of said preferred embodiment, the remaining components which in the case of conventional rotary presses ensure the movement of the one-part punches, such as pressure rollers and low tension rails for optional use, are also each required in twin configurations.

The division of the upper and/or lower punch into two component punches which act independently of one another may be accomplished in a variety of ways. Thus, for example, it is conceivable to replace an angular or circular punch, in the first case, by two half-angles or two triangles and in the latter case by two semicircles. This leads to multiphase tablets in which at least one end face has a parting line, which may be given visual emphasis by the use of differently colored premixes. The diversity of design possibilities is subjected in this case to virtually no boundaries, with the consequence that the abovementioned example may be extended to the effect that the parting line is not a straight line but rather a more or less strongly and frequently curved line. In this way, it is possible to produce a very wide variety of tablets.

Since there is a sharp increase in performance problems such as punch caking, capping, excessive wear, etc. as the complexity of the pressing faces of the two component punches increases, preference is given to processes of the invention wherein the upper and/or lower punch(es) used comprise(s) a punch constructed of two component punches which are movable independently of one another and parallel with respect to one another, preference being given to punches comprising a central mandrel embraced by an annular punch.

In this case too there are a large number of design possibilities for annular punch and central mandrel. For instance, in the case of an angular die and an annular punch adapted to this die, with an angular outline of the end face (pressing face), it is possible to use an angular or a circular central mandrel, leading to different plan views of the surface of the tablets produced. Analogously, it is possible to produce circular or oval tablets with an angular or circular insert. For the reasons referred to above, preference is given to an apparatus of the invention wherein the central mandrel has an ellipsoidal, circular or rectangular end face.

In this embodiment, the annular punch surrounding the central mandrel has a likewise circular bore in which the central mandrel may be moved freely up and down. This geometry has no influence on the external outline of the end face of the die (and thus of the annular punch)—here, as before, all variant forms are possible. On esthetic grounds, however, likewise circular dies will be preferred. In the case of this specific embodiment, the annular punch has an outline in the form of two concentric circles.

The comments below refer only to the preferred embodiment with annular punch and central mandrel, but may be applied in a completely analogous manner to other component punch geometries. In this case, it would be possible to replace terms such as “annular” and “core” by “left-hand region” and “right-hand region” or analogs familiar to the skilled worker.

It is of course also possible to equip the press punches with a plurality of movable mandrels, so that one punch may be constructed, for example, from three component punches (“annular punch” with two “holes” and two mandrels) or from four component punches (“annular punch” with three “holes” and three mandrels). As the punches become increasingly divided, however, the requirements imposed on the guiding of the individual component punches become ever more stringent, so that from a process engineering standpoint preference is given to punches constructed from two component punches.

The design of the bottom punches as annular punches with a central mandrel may be utilized for the purpose of precise centering of core tablets. In this case, ideally, the pressing face of the central mandrel is adapted to the base area of the core tablets produced in step a). If, then, the central mandrel of the lower punch is lowered before step b) of the process is implemented, the core tablet (in the case of a plurality of lowerable central mandrels: the tablets) can be metered with a precise fit. After the die has been filled up with premix, the central mandrel of the lower punch can be raised again, so that the lower punch has a planar pressing face. Corresponding variants of the process of the invention, wherein the pressing face of the lower punch in step b) of the process has at least one cavity, are preferred.

At the point of final compression, the lower punch pressing face is preferably planar, which makes the subsequent ejection easier. Processes wherein the pressing face of the lower punch in step f) of the process is planar are preferred embodiments of the process of the invention.

If not just one premix is metered into the die of the tableting machine, but instead a plurality of premixes, then smoothing of the surface may take place after each filling shoe by gentle applied pressure with the upper punch, in order to obtain a clean phase boundary line between the individual phases composed of different premixes. Depending on formulation and process design, this step may also be omitted: it should be taken into account here that the lower the pressure load on the initially introduced premix, the better the adhesion between the individual layers. For esthetic reasons, however, preference is given to processes wherein after each step c) the particulate premix(es) is/are smoothed by lowering of the upper punch.

The abovementioned remarks relating to the lower punches may also be addressed analogously to the upper punches. Here too, it is possible to use upper punches whose pressing face has at least temporary elevations and/or depressions, it again being possible to use the above-described “mandrel punches”. Especially in the case of the above-described variant of the “smoothing” of the intermediate surfaces, preference is given to processes wherein the pressing face of the upper punch has at least one elevation when it is lowered.

Independently of whether one or more premixes are introduced and of whether smoothing takes place between the individual additions of premix, preference is given to processes wherein the pressing face of the upper punch in step f) is planar.

Where use is made of lower punches whose pressing face is nonplanar at least once in the process of the invention, it is possible to use conventional upper punches, resulting in processes wherein the pressing face of the upper punch is planar during the entire process.

Alternatively, it is also possible in the process of the invention to use upper punches which by dint of their construction have (an) elevation(s) on the pressing face. In contrast to the punches with a central mandrel, no additional guide rails are necessary in this case, since the “mandrel” protrudes permanently from the punch surface. Such variants of the process of the invention, wherein the pressing face of the upper punch has at least one elevation during the entire process, are likewise preferred.

The present invention therefore additionally provides processes for producing multiphase laundry detergent or cleaning product tablets, which comprise the steps of

a) producing core tablets comprising active substance,

b) optionally inserting one or more core tablets from step a) into a die of a tableting press,

c) filling at least one particulate premix into the die of the tableting press,

d) optionally supplying one or more core tablets from step a) into the die of the tableting press,

e) optionally repeating steps b) and/or c) one or more times,

f) carrying out compression to give tablets having at least one cavity,

g) supplying core tablet(s) from step a) into the cavity/cavities of the tableting press,

h) pressing the core tablet(s) into the cavity/cavities.

Owing to the fact that the upper punch has at least one elevation, final compression in step f) produces tablets having at least one cavity. This cavity/these cavities is/are subsequently filled with (a) core tablet(s) which in step h) of the process of the invention is/are pressed into the cavity/cavities in order to obtain planar tablet surfaces.

In this case, preferred processes of the invention are those wherein compression in step f) takes place using an upper punch whose embossing element has at least one stud surrounded by a planar base area.

The term “embossing element” which is used occasionally below is synonymous with “pressing face” and denotes that part of the press punch which comes into contact with the material to be tableted.

As already mentioned, the pressing forces are directed vertically onto the planar base area. Since the planar base area represents the lowest level in the profile of the embossing element, the compression of the material for compression is at its lowest in this region. This has the further consequence that the areal pressures to be expected in the region of the base area are also lower than in the region of the upwardly domed stud. For these reasons, the material of the base area need not necessarily be incompressible, especially since only normal forces are to be expected from the pressure geometry. Accordingly, the press punches may also be designed in such a way that the elevation(s) is/are comprised of a hard material while the base area (i.e., the remaining part, which comes into contact with the tableting mixture, of the pressing face from which the elevation(s) protrudes/protrude) is coated with soft materials in order to increase the surface quality of the resultant tablets. Corresponding processes wherein the base area of the embossing element is flexible in the pressing operation and the stud or studs is or are incompressible and at least adhesion-reducingly coated are preferred embodiments.

The structure of beds of substances in the form of powders or fine crystals, although regardable as uniform in relation to relatively large areas or volumes, is nevertheless very different on the micro scale. As a result of these different density conditions on the micro scale, the uniform pressing forces bearing on the surface of the base area material are opposed by different resistances of the material intended for compression. A result of this is that different specific pressures occur at points of the surface which are spaced apart on the micro scale, and, accordingly, when the base area element is of compressible material, very slightly different deformations of the material occur. This phenomenon, referred to here as flexing, results in the formation of different normal forces and transverse forces at the material surface, thereby preventing or at least greatly reducing the tendency for adhesion of material to the surface of the embossing element in the region of the base area.

A tableting punch whose embossing element is configured in the form described has the advantageous effect of preventing sticking or at least reducing adhesion. Using such a pressing tool it is possible to attain long tool service lives and flawless tablet surfaces.

In one embodiment, in which the embossing element of the tableting punch is not to be limited by the base area on the side, and this base area is surrounded by an essentially uniform, incompressible edge strip, effects of the compression and deformation events at the inner wall of the die on the compressible base area are ruled out. An outwardly increasing beveling of the edge strip has the advantageous effect of a clean distribution of material in the die and a stabilization of the tablet structure.

Very particular advantages in connection with the production of the tableting punch and the durability of the pressing tool are ensured in an embodiment wherein the embossing element comprises a plurality of individual parts. Judiciously, the extent and tailoring of the individual parts are oriented to the different materials and material requirements, respectively. For instance, the individual manufacture of the ellipsoidal stud from incompressible material with an at least adhesion-reducing coating on the outer surface, of a platelike element of flexible material for the base area, and of an annular element of incompressible material for the edge strip constitutes an advantageous delimitation for the design of the individual parts, which is appropriate on account of their different materials.

As described earlier on above, the coating of the stud must be both hard and resistant to high areal loads but on the other hand must also have a friction-reducing or lubricating quality. For this purpose it has proven very suitable to use nickel-containing surface coatings in which very fine PTFE particles (Teflon) have been included. These particles give the coating qualities of preventing sticking and preventing material wear. Another embodiment which has proven suitable, as an alternative to the first one described, is an embodiment of the adhesion-reducing coating wherein the base coating material comprises a nickel-phosphorus alloy rather than nickel.

As a further alternative for the surface coating with an at least adhesion-reducing effect, but which also otherwise meets the hardness and resistance requirements, a coating of graphite containing diamond particles has proven appropriate. In this case the surface of the stud is coated with a layer of graphite, which is known to be lubricating or slip promoting, and which in this case acts simultaneously as a binder for the fixing of diamond particles, which for their part give the surface the requisite hardness. Tests with these stud surface coatings have shown that, even at very long tool service lives, no instances of sticking of material were observed. Accordingly, preference is given to processes wherein the at least adhesion-reducing coating of the stud or studs comprises Ni-P-PTFE or C-diamond.

In the course of the compression of powder mixtures to tablets, problems may arise on account of the fact that there may be instances of powder caking at the boundary line between the semiellipsoid and the plastic insert. This caking leads to instances of flaking along the edge of the depression, which especially when compressing colored premixes detracts from the appearance of the tablets. In addition, using the materials specified to date, it is very complex in technical terms to realize complicated stud geometries, such as text markings or other shapes, for example.

Instead of an at least adhesion-reducing coating of the stud, this stud may be manufactured completely from adhesion-reduced materials. Plastics in particular have proven appropriate for this purpose. A further preferred embodiment of the present invention therefore envisages the stud being not only adhesion-reducingly coated but instead manufactured completely from adhesion-reducing material. Particular preference is given in this case to tableting punches whose stud is manufactured from plastic.

In the context of the present invention, the term “plastics” is characteristic of materials whose essential constituents comprise those macromolecular organic compounds which are produced synthetically or by modifying natural products. In many cases they are meltable and shapeable under certain conditions (heat and pressure). Plastics are, therefore, in principle, organic polymers and may be classified alternatively by their physical properties (thermoplastics, thermosets and elastomers), by the nature of the reaction for their preparation (addition polymers, polycondensates and polyadducts), or by their chemical nature (polyolefins, polyesters, polyamides, polyurethanes, etc.).

In the context of the present invention, the stud, which in the stated preferred embodiments is manufactured of plastic, is an elevation on the embossing element of the tableting punch. The area on which the stud is applied may likewise adopt different forms, with a host of possibilities being conceivable from the level planar area through to hemispherical designs. In the context of the present invention it is preferred on the one hand for the area on which the stud is seated to be planar and on the other hand to protrude beyond the stud in all directions on the plane, i.e., for the stud to be seated as an elevation on an area and at no point to extend directly to the edge of the pressing tool or to form this edge. Preferably, the base area on which the stud is seated is also manufactured of plastic, so that preference is given to tableting punches wherein the stud and the planar base area are manufactured of plastic.

In the context of the present invention it is particularly preferred for the material of the stud to be harder than that of the base area. Processes of the invention wherein the embossing elements of the upper punches have a stud surrounded by a planar base area, the base area and the stud being manufactured of plastics and the material of the stud being harder than that of the base area, are therefore preferred in accordance with the invention.

In the context of the present invention, the term “hardness” is the designation for the resistance offered by a solid body to penetration by another body. Whereas in the case of minerals, for example, the so-called scratch hardness (Mohs hardness) is measured, different techniques of hardness testing have become established in industry. The most frequent of those employed are Brinell, Rockwell and Vickers techniques (especially for steel and other metals). To determine the Brinell hardness (HB, ball pressure hardness, DIN 50351), standardized steel or Widia balls with a diameter of 10 mm and a test load P (expressed in N) are pressed without impact into the materials under test and the surface area O (in mm²) of the impressed dome of diameter d is found. The Brinell hardness is then given by:

$$HB = \frac{P}{O} = \frac{1}{9.817 π} \cdot \frac{2 P}{D \cdot ( D - \sqrt{{D}^{2} - {d}^{2}} )}$$

In the case of the measurement of the Rockwell hardness (HR), which is suitable for higher hardness levels, either a diamond cone (HRC) or steel balls of different diameters (HRB) are pressed into the material. To measure the Vickers hardness (HB), a diamond pyramid is used which has an included angle between faces of 136°; here too, the hardness is defined as the load relative to the indentation surface area (N/mm²). In the case of this testing technique, the indentations are very small, so that it is possible to measure the hardness even of very thin layers. The same applies to the Knoop hardness (HK), determined using a diamond pyramid with a rhombic base. In the case of impact hardness measurement, the basis for calculation that is used is the diameter of a ball indentation produced by impact with a hand-held hammer (Poldi hammer, scleroscope) or by means of a tensioned spring. Another, likewise dynamic technique of measuring hardness is the rebound technique. The Shore hardness determined in this way is measured in the case of steel as rebound hardness, by the falling ball test, or in the case of rubber and other elastomers as penetration resistance relative to a frustum.

In the case of harder plastics, e.g., hard thermoplastics and especially thermosets, the ball pressure hardness is measured as the ratio of test force and surface area of the impression of a steel ball (5 mm diameter) after 10, 30 or 60 seconds under load.

Very particular advantages in connection with the production of the tableting punch and the durability of the pressing tool are ensured in an embodiment wherein the embossing element comprises a plurality of individual parts. Judiciously, the extent and tailoring of the individual parts are oriented to the different materials and material requirements, respectively. For instance, the individual manufacture of the ellipsoidal stud of the relatively hard plastic, of a platelike element of the relatively soft plastic, preferably a flexible material, for the base area, and of an annular element of incompressible material for the edge strip constitutes an advantageous delimitation for the design of the individual parts, which is appropriate on account of their different materials.

As described earlier on above, the stud consists of a harder plastic than the base area. Hard plastics comply in particular with the requirement that the stud be both hard and resistant to high areal loads and also have a friction-reducing or lubricating quality.

Plastics materials which have proven appropriate for the stud are, in particular, polyolefins, preferably polyethylene or polypropylene. Polyethylenes (PE) are polyolefin polymers containing groups of the type

—[CH₂—CH₂]

as the characteristic base unit of the polymer chain. Polyethylenes are prepared by addition polymerization of ethylene in accordance with two fundamentally different methods, the high-pressure process and the low-pressure process. The resulting products are often referred to accordingly as high-pressure polyethylene and low-pressure polyethylene respectively; they differ primarily in terms of their degree of branching and, relatedly, in their degree of crystallinity and their density. Both processes may be conducted as solution polymerization, emulsion polymerization or gas phase polymerization processes.

In the case of the high-pressure process, branched polyethylenes of low density (approximately 0.915-0.935 g/cm³) and degrees of crystallinity of approximately 40-50% are obtained, which are referred to as LDPE grades. Products with higher molecular mass and, consequently improved strength and stretchability bear the abbreviated designation HMW-LDPE (HMW=high molecular weight). By copolymerization of ethylene with longer-chain olefins, especially with butene and octene, it is possible to reduce the pronounced degree of branching of the polyethylenes produced in the high-pressure process; the copolymers have the abbreviation LLD-PE (linear low density polyethylene).

The macromolecules of the polyethylenes from low pressure processes are substantially linear and unbranched. These polyethylenes (HDPE) have degrees of crystallinity of 60-80% and a density of approximately 0.94-0.965 g/cm³. They are particularly suitable as stud materials.

Polypropylenes (PP) are thermoplastic polymers of propylene comprising base units of the type

—[CH(CH₃)—CH₂].

Polypropylenes may be prepared by stereospecific polymerization of propylene in the gas phase or in suspension to give highly crystalline isotactic polypropylenes or less crystalline syndiotactic polypropylenes or amorphous atactic polypropylenes. Of particular importance in industry is the isotactic polypropylene, in which all methyl groups are located on one side of the polymer chain. Polypropylene is notable for high hardness, resilience, stiffness and thermal stability and is therefore an ideal stud material in the context of the present invention.

The mechanical properties of the polypropylenes are improved by reinforcement with talc, chalk, wood flour or glass fibers, and the application of metallic coatings is also possible.

Besides the polyolefins, polyamides are stud materials which may be used with preference in the context of the present invention. Polyamides are high molecular mass compounds comprising building blocks linked by peptide bonds. With a few exceptions, the synthetic polyamides (PA) are thermoplastic, chainlike polymers with repeating acid amide groups in the main chain. According to chemical structure, the so-called homopolyamides may be divided into two groups: the aminocarboxylic acid types (AS) and the diamine-dicarboxylic acid types (AA-SS); here, A denotes amino groups and S carboxyl groups. The former are formed from a building block by polycondensation (amino acid) or addition polymerization (ω-lactam), the latter from two building blocks by polycondensation (diamine and dicarboxylic acid).

The polyamides comprising unbranched aliphatic building blocks are coded according to the number of carbon atoms. For example, the designation PA 6 is the polyamide constructed from ε-aminocaproic acid or ε-caprolactam. PA 12 is a poly(s-laurolactam) from ε-laurolactam. In the case of the AA-SS type, first the carbon number of the diamine and then that of the dicarboxylic acid are stated: PA 66 (polyhexamethyleneadipamide) is formed from hexamethylenediamine (1,6-hexanediamine) and adipic acid, PA 610 (polyhexamethylenesebacamide) from 1,6-hexanediamine and sebacic acid, PA 612 (polyhexamethylenedodecanamide) from 1,6-hexanediamine and dodecanedioic acid. The stated polyamide types are stud materials which are preferred in the context of the present invention.

Polyurethanes (PU) are polymers (polyadducts) obtainable by polyaddition from dihydric and higher polyhydric alcohols and isocyanates, containing groups of type

—[CO—NH—R²—NH—CO—O—R¹—O]

as characteristic basic units of the basic macromolecules, in which R¹ is a low molecular mass or polymeric diol radical and R² is an aliphatic or aromatic group. Industrially important PUs are produced from polyesterdiols and/or polyetherdiols and, for example, from 2,4- and/or 2,6-toluene diisocyanate (TDI, R²═C₆H₃—CH₃), 4,4′-methylenedi(phenyl isocyanate) (MDI, R²═C₆H₄—CH₂—C₆H₄), or hexamethylene diisocyanate [HMDI, R²═(CH₂)₆]. Tableting punches whose studs comprise a polyurethane are likewise preferred in accordance with the invention.

The stated plastics may be used alone as stud materials, but may also be provided with coatings or laminations of metals or other substances. In the context of the present invention it has proven particularly appropriate to use glass fiber reinforced plastics as stud material. Glass fiber reinforced plastics (GRPs) are composite materials comprising a combination of a polymer matrix and reinforcing glass fibers. The glass materials used for fiber reinforcement in the GRPs are in the form of fibers, yarns, rovings (glass silk strands), nonwovens, wovens, or mats. Suitable polymeric matrix systems for GRPs include both thermosets (such as epoxy resins, unsaturated polyester resins, phenolic resins and furan resins, for example) and thermoplastics (such as polyamides, polycarbonates, polyacetals, polyphenylene oxides and sulfides, polypropylenes, and styrene copolymers, for example). The weight ratio between reinforcing material and polymer matrix is usually in the range of 10:90-65:35, the strength properties of the GRPs generally increasing up to a reinforcement content of approximately 40% by weight.

The GRPs are produced predominantly in compression processes; further important manufacturing processes are hand layup, spray layup, continuous impregnation, filament winding, and centrifugal processes. In many cases the process starts from what are known as prepregs, glass fiber materials preimpregnated with resins, which are cured using heat and pressure. Relative to the unreinforced matrix polymers, the GRPs feature increased tensile, flexural and compressive strength, impact toughness, dimensional stability, and stability with respect to the effect of heat, acids, salts, gases or solvents. In the context of the present invention, glass fiber reinforced polytetrafluoroethylene and glass fiber reinforced polyamides have proven particularly appropriate stud materials.

As already mentioned above, an elevation from the stud surface may be realized not only by the insertion of a disk but also by the manufacture of a material body of identical geometric construction. Plastics are particularly suitable for such geometries, polyamides having proven particularly appropriate.

The dimension of the stud may be adapted to the dimension of the tablet to be produced, so that the resulting cavity in the tablet has appropriate dimensions in comparison to the tablet volume. For customary tablet geometries and tablet sizes it has proven advantageous for the stud to have a volume of 0.5 to 5 ml, preferably from 0.6 to 3 ml, and in particular from 0.8 to 2 ml. The volume of the stud is to be understood as the volume which the stud embosses as a depression into the tablet. The term stud volume therefore characterizes the volume of the “stud head”, not including the “stem”, i.e., the elements which serve to affix the elevation on the tableting punch. Corresponding processes wherein the embossing element has a stud possessing a volume of from 0.5 to 5 ml, preferably from 0.6 to 3 ml, with particular preference from 0.8 to 2 ml, are preferred embodiments of the process of the invention.

The stud or studs protrude(s) preferably to a marked extent from the base area of the embossing element. Processes of the invention wherein the embossing element has one or more studs each protruding at least 1 mm, preferably at least 2 mm, and in particular at least 3 mm, from the base area are preferred.

The adhesion preventing or at least adhesion reducing effect of the flexible material for the formation of the base area has been described above. As already mentioned, it is preferred for the base area to comprise a reversibly deformable material having a hardness of from 40 to 99 Shore A in accordance with DIN 53505. Tests have shown that very good results may be achieved, for example, using the polyurethane material Vulkollan or the PVC material Mipolam. Over deployment times of several thousand compressions, no instances of adhesion at all were found on the base area material.

The dimension of the base area is also adapted to the dimension of the tablet to be produced, so that the top and bottom of the tablets have appropriate dimensions in comparison to the tablet volume. For customary tablet geometries and tablet sizes, processes which have proven advantageous are those wherein the base area of the embossing element is from 2.6 to 60 cm², preferably from 5 to 40 cm², with particular preference from 7.5 to 20 cm².

As already mentioned, the press operations may be optimized by designing the tableting punch in such a way that the base area is surrounded by an incompressible, essentially uniform edge strip. In preferred embodiments of the present invention, this edge strip is situated internally at the level of the base area top edge and is beveled with an outward ascent.

For the production of tablets for machine dishwashing, for example, it is preferred for these tablets to have a rectangular form, so that they may be introduced into dosing compartments of commercially customary machines. Accordingly, tableting punches whose base area is essentially rectangular and has preferably rounded corners are preferred.

The abovementioned preferred dimensions of base area and stud may be realized in a punch which is used to produce laundry detergent and cleaning product tablets. In the case of tableting punches which are preferred in the context of the present invention, the essentially rectangular base area including edge strip has dimensions of approximately 36×26 mm and the ellipsoid of the stud surrounded by it has approximately the semiaxis lengths of a=8.3, b=11.5 and c=5 mm.

It is of course also possible to produce circular laundry detergent and cleaning product tablets with a punch of the invention. Another important embodiment of the present invention therefore envisages the tableting punch wherein the base area is essentially circular.

Reference has already been made to the fact that very particular advantages in connection with the production of the tableting punch and the durability of the compression tool are realized in an embodiment wherein the embossing element comprises a plurality of individual parts which can be fixed joined together. Judiciously, the extent and tailoring of the individual parts are oriented to the different materials and/or material requirements. As already stated, in this way the individual manufacture of the ellipsoidal stud from incompressible material which is at least adhesion-reducingly coated on the outer surface, or from completely adhesion-reduced plastic, of a platelike element from flexible material for the base area, and of an annular element from incompressible material for the edge strip, is an advantageous delimitation for the design of the individual parts which is appropriate owing to their different materials.

The shape of the stud protruding from the base area may be chosen freely, it having already been mentioned that this shape is preferably approximated to the shape of the core tablets produced in step a). Nevertheless, it is possible here to realize sphere sections, frustums, ellipsoid sections, cubes, prisms, etc. as the stud geometry. In preferred processes, the outer surface of the stud(s) forms an angle with respect to the base area of the embossing element of from 90 to 160°, preferably from 90 to 140°, and in particular from 100 to 120°.

It is also preferred for the “base” of the depression of the tablets produced in step f) to run parallel to the underside of the tablet. Corresponding processes wherein the pressing face of the stud(s) runs parallel to the base area of the embossing element are advantageous.

As already mentioned, it is of advantage if the core tablet(s) a) may be inserted positively into the cavity in step g).

The impression of the core tablet(s) into the cavity is the last step in the process of the invention, being followed by the ejection of the tablets from the die. The pressing pressure for impression of the core tablets also depends on the composition of base tablet and core tablet, but is in most cases below the pressing pressures required for compression in step f). Preferred processes are those wherein the compression in step h) takes place at pressing pressures of from 0.1 to 50 kN cm², preferably from 0.5 to 25 kN cm⁻², and in particular from 1 to 15 kN cm⁻².

The mass of the core tablet may vary depending on the ingredients of the core tablet and their desired proportion in the overall tablet. Preference is given here to processes of the invention wherein the mass of the core tablet a) is more than 0.5 g, preferably more than 1 g, and in particular more than 2 g.

Irrespective of the mass of the core tablet, it is further preferred for this core tablet to possess a certain spatial extent, preference being given to processes of the invention wherein the core tablet a) has a base area of at least 50 mm², preferably of at least 100 mm², and in particular of at least 150 mm².

In the case of core tablets which do not consist of two plane-parallel faces connected by an outer surface, the definition of a base area is not useful. In this case, the end products of preferred process steps a) meet the condition that the large horizontal sectional area complies with the values stated above.

Generally, core tablets having a point-symmetrical base area are preferred, particular preference being given to processes of the invention wherein the core tablet a) possesses a circular base area.

Independently of the shape of the core tablet and irrespective of the nature of its preparation process (see later on below), it is preferred for the core tablet to have a lower density than the overall end product of the process of the invention. In terms of absolute values, preference is given here to processes wherein the core tablet has a density of less than 1.4 g cm⁻³, preferably less than 1.2 g cm⁻³, and in particular less than 1.0 g cm⁻³.

Where the end product of the process of the invention comprises more than one core tablet, the figures stated above apply preferably to all core tablets individually, i.e., not to the sum of the core tablets but rather to each individual core tablet.

The above details on mass, geometry and density of the core tablets may also be applied to the end products of the process of the invention, i.e., to the tablets per se. Here, preference is given to processes wherein the mass of the overall laundry detergent or cleaning product tablet is from 10 to 100 g, preferably from 15 to 80 g, with particular preference from 18 to 60 g, and in particular from 20 to 45 g, while in preferred processes the base area of the end products is chosen so that the laundry detergent or cleaning product tablet has a base area of at least 500 mm², preferably of at least 750 mm², and in particular of at least 1000 mm².

Regarding the density, preference is given to processes of the invention wherein the overall tablet has a density of more than 1.1 g cm⁻³, preferably more than 1.2 g cm⁻³, and in particular more than 1.4 g cm⁻³.

It has proven advantageous if the premix which is filled into the die in step c) of the process of the invention satisfies certain physical criteria. Preferred processes are those, for example, wherein the particulate premix in step c) has a bulk density of at least 500 g/l, preferably at least 600 g/l, and in particular at least 700 g/l.

The particle size of the premix filled in in step c) also preferably satisfies certain criteria: processes wherein the particulate premix in step c) has particle sizes of between 100 and 2000 μm, preferably between 200 and 1800 μm, with particular preference between 400 and 1600 μm, and in particular between 600 and 1400 μm, are preferred in accordance with the invention. A further-narrowed particle size in the premixes for compression may be set in order to obtain advantageous tablet properties. In preferred variants of the process of the invention, the particulate premix filled in in step c) has a particle size distribution in which less than 10% by weight, preferably less than 7.5% by weight, and in particular less than 5% by weight of the particles are larger than 1600 μm or smaller than 200 μm. In this context, relatively narrow particle size distributions are further preferred. Particularly advantageous process variants are those wherein the particulate premix added in step c) has a particle size distribution in which more than 30% by weight, preferably more than 40% by weight, and in particular more than 50% by weight of the particles have a particle size of between 600 and 1000 μm.

The implementation of the process of the invention is not restricted to the introduction simply of one particulate premix and, subsequently, compression to form a tablet. Instead, the process step c) may also be implemented a number of times in succession—interrupted if desired by optional process steps d)—so that in a manner known per se multilayer tablets are produced by preparing two or more premixes which are compressed with one another. In this case, the premix which is introduced first is gently precompressed, in order to acquire a smooth top face which extends parallel to the bottom of the tablet, and final compression to form the finished tablet takes place after the second premix has been introduced. In the case of tablets with three or more layers there is a further, optional precompression following the addition of each premix, before the tablet undergoes final compression after the last premix has been added. In the context of the process of the invention it is of course also possible to dispense entirely with intermediate compression, so that direct compression takes place only after the last premix has been introduced and/or the last core tablet supplied.

The end products of the process of the invention may be manufactured in predetermined three-dimensional forms and predetermined sizes. Suitable three-dimensional forms include virtually any practicable designs—i.e., for example, bar, rod or ingot form, cubes, blocks, and corresponding three-dimensional elements having planar side faces, and in particular cylindrical designs with a circular or oval cross section. This latter design covers forms ranging from tablets through to compact cylinders having a height-to-diameter ratio of more than 1.

The tablet produced may take on any geometric form whatsoever, with particular preference being given to concave, convex, biconcave, biconvex, cubic, tetragonal, orthorhombic, cylindrical, spherical, cylindrical-segmentlike, discoid, tetrahedral, dodecahedral, octahedral, conical, pyramidal, ellipsoid, pentagonally, heptagonally and octagonally prismatic, and rhombohedral forms. It is also possible to realize completely irregular outlines such as arrow or animal forms, trees, clouds, etc. If the tablet produced has corners and edges, these are preferably rounded off. As additional visual differentiation, an embodiment having rounded corners and beveled (chamfered) edges is preferred.

The end products of the process of the invention are produced by tableting; this process may be used optionally to produce the core tablet. In general, in the case of tableting, preference is given to processes of the invention wherein the compression in step a) and/or f) takes place at pressures of from 1 to 100 kN cm⁻², preferably from 1.5 to 50 kN cm⁻², and in particular from 2 to 25 kN cm⁻².

While step f) of the process of the invention is a mandatory process step, i.e., the process of the invention falls within the group of tableting processes, the core tablets may also be produced by other processes familiar to the skilled worker. A preferred method of obtaining core tablets comprises melting the ingredients and pouring them into molds, where they solidify. This preferred process, in which the core tablets are produced in step a) by casting, will be employed advantageously wherever the ingredients of the core tablet are meltable. This production process is preferred for the core tablets on account of the fact that with certain meltable substances it is possible to bring about additional effects of accelerated or retarded dissolution.

Where the use of meltable matrix substances is out of the question on material or formulation grounds, sintering is another preferred process for producing the core tablets. Corresponding processes wherein the core tablets are produced in step a) by sintering are likewise preferred.

If temperature stress on the ingredients of the core tablet is to be avoided, other production processes are advisable. Among these, an important position is adopted in particular by tableting, so that preferred processes include those wherein the core tablets are produced in step a) by tableting.

More detailed information on the tableting to produce core tablets in step a) of the process of the invention can be found later on below in the context of the detailed description of process step f).

Another preferred production process for the core tablets a) comprises providing them in the form of a capsule. Processes wherein the core tablet is a capsule are likewise preferred embodiments of the present invention.

Irrespective of the method by which the core tablets a) are produced, certain substances customary in laundry detergents or cleaning products are preferably included in the core tablets. In this context, the process of the invention is not restricted to the use of only one kind of core tablet where all of the core tablets comprise the same active substance in the same amounts.

Instead, in accordance with the invention it is also possible for two or more core tablets of different composition to be inserted into the die of the tableting press in steps b) and/or d). Likewise possible without problems is the placing of core tablets differing in shape. Furthermore, different core tablets comprising the same active substance in different amounts (based on the core tablet) may be produced and used in the process of the invention.

A particularity occurs in the process of the invention if only one core tablet is transferred to the die: in the sequence of process steps a)-c)-d)-f) a tablet is obtained in the case of which the core tablet is located on the top face of the resultant tablet. For certain reasons it may be advantageous first to transfer a core tablet into the empty die and then to fill up this die with premix. This would correspond to a sequence of process steps a)-d)-c)-f), or in principle a process a)-b)-c)-f) in which step d) is omitted. Since, however, step d) is not optional but is carried out mandatorily, steps c) and d) of the process of the invention may if desired be carried out in the opposite sequence. This results in a tablet in the case of which the core tablet is located on the underside of the resultant tablet.

Irrespective of whether only one core tablet is transferred to the die or whether two, three, four or more core tablets are supplied, certain active substances are preferably included in the core tablet(s). For instance, preference is given to processes of the invention wherein the core tablet a) comprises surfactant ingredient(s). These substances are described in detail later on below. Based on the individual core tablet, preferred amounts of surfactant(s) in the tablet(s) are from 0.5 to 80% by weight, preferably from 1 to 70% by weight, and in particular from 5 to 60% by weight.

Also preferred in accordance with the invention are processes of the invention wherein the core tablet a) comprises enzyme ingredient(s). These substances are likewise described in detail later on below. Based on the individual core tablet, preferred amounts of enzyme(s) in the core tablet(s) are from 0.01 to 50% by weight, preferably from 0.1 to 25% by weight, and in particular from 1 to 15% by weight.

Processes wherein the core tablet a) comprises bleach and/or bleach activator ingredient(s) are likewise preferred. The representatives of these classes of substance are also described in detail later on below. Based on the individual core tablet, preferred amounts of bleaches in the core tablet(s) are from 0.5 to 100% by weight, preferably from 1 to 90% by weight, and in particular from 5 to 80% by weight, while preferred amounts of bleach activators are in the range from 0.1 to 70% by weight, preferably from 0.5 to 50% by weight, and in particular from 1 to 25% by weight.

For reasons of accelerated dissolution it may be desired to accelerate the disintegration of the core tablets. Consequently, preference is also given to processes wherein the core tablet a) comprises disintegration aids and/or gas-forming systems as ingredients. These substances are described later on below in the context of the detailed description of the ingredients. Based on the individual core tablet, preferred amounts of disintegration aids in the core tablet(s) are from 0.1 to 30% by weight, preferably from 0.5 to 20% by weight, and in particular from 2.5 to 15% by weight, whereas effervescent systems are used advantageously in amounts of from 1 to 80% by weight, preferably from 2.5 to 70% by weight, and in particular from 5 to 60% by weight. Particular preference is given to the combination of effervescent systems with enzymes.

Processes of the invention wherein the core tablet a) comprises water softeners and/or complexing agents as ingredients are likewise preferred. Examples of appropriate water softeners are ethylenediaminetetraacetic acid (EDTA), nitrilotriacetate (NTA) and related substances, although ion exchangers and other complexing agents, as described in detail later on below, may also be used with preference.

Following process step a), the core tablets may optionally be coated or treated with encapsulants. Preference is given to corresponding processes wherein production of the core tablets in step a) is followed by coating and/or encapsulation of the core tablets.

Irrespective of the production process for the core tablets, they may of course likewise adopt any form whatsoever, reference being made to the above embodiments. A multiphase design of the core tablets is also possible and preferred in the context of the present invention.

Where the core tablets are produced by a casting process, they preferably include one or more meltable substances having a melting point of more than 30° C., preferred processes being those wherein the core tablet(s) produced in step a), based on its/their weight, comprises/comprise at least 30% by weight, preferably at least 37.5% by weight, and in particular at least 45% by weight, of meltable substance(s) having a melting point of more than 30° C.

Processes wherein the core tablet(s) comprises/comprise one or more substances having a melting range between 30 and 100° C., preferably between 40 and 80° C., and in particular between 50 and 75° C., are particularly preferred.

These meltable substances which are used in the core tablets in this process variant are subject to a variety of requirements, relating on the one hand to the melting behavior or, respectively, solidification behavior but also on the other hand to the material properties of the melt in the solidified state, i.e., in the core tablets. Since the core tablet is to be durably protected against ambient influences in transit or storage, the meltable substance must possess a high stability with respect, for example, to impacts occurring in the course of transit. The meltable substance should, therefore, have either at least partially elastic or at least plastic properties, in order to react by elastic or plastic deformation to any impact that does occur and not to become crushed. The meltable substance should have a melting range (solidification range) situated within a temperature range in which other ingredients of the core tablets are not exposed to any excessive thermal load. On the other hand, however, the melting range must be sufficiently high still to offer effective protection for active substances that are used, at least at slightly elevated temperature. In accordance with the invention, the meltable substances have a melting point above 30° C., preference being given to processes wherein the core tablets comprise only meltable substances having melting points of more than 40° C., preferably more than 45° C., and in particular more than 50° C. Particularly preferred core tablets comprise as ingredient c) one or more substances having a melting range between 30 and 100° C., preferably between 40 and 80° C., and in particular between 50 and 75° C.

It has proven advantageous for the meltable substance not to exhibit a sharply defined melting point, as encountered commonly with pure, crystalline substances, but instead to have a melting range which covers, in some cases, several degrees Celsius.

The meltable substance preferably has a melting range which lies between about 52.5° C. and about 80° C. In the present case that means that the melting range occurs within the stated temperature interval, and does not denote the width of the melting range. The width of the melting range is preferably at least 1° C., more preferably from about 2 to about 3° C.

The abovementioned properties are in general possessed by what are called waxes. The term “waxes” is applied to a range of natural or synthetically obtained substances which melt without decomposition, generally at above 50° C., and are of comparatively low viscosity, without stringing, at just a little above the melting point. They have a highly temperature-dependent consistency and solubility.

According to their origin, the waxes are divided into three groups: the natural waxes, chemically modified waxes, and the synthetic waxes.

The natural waxes include, for example, plant waxes such as candelilla wax, carnauba wax, japan wax, esparto grass wax, cork wax, guaruma wax, rice germ oil wax, sugarcane wax, ouricury wax, or montan wax, animal waxes such as beeswax, shellac wax, spermaceti, lanolin (wool wax), or uropygial grease, mineral waxes such as ceresin or ozokerite (earth wax), or petrochemical waxes such as petrolatum, paraffin waxes or microcrystalline waxes.

The chemically modified waxes include, for example, hard waxes such as montan ester waxes, sassol waxes, or hydrogenated jojoba waxes.

By synthetic waxes are meant, in general, polyalkylene waxes or polyalkylene glycol waxes. As meltable substance it is also possible to use compounds from other classes of substance which meet the stated requirements in terms of softening point. Examples of synthetic compounds which have proven suitable are higher esters of phthalic acid, especially dicyclohexyl phthalate, which is available commercially under the name Unimoll 66 (Bayer AG). Also suitable are synthetically prepared waxes from lower carboxylic acids and fatty alcohols, an example being dimyristyl tartrate, which is available under the name Cosmacol® ETLP (Condea).

Preferably, the meltable substance present in the core tablets comprises a paraffin wax fraction. That means that at least 10% by weight of the total meltable substances present, preferably more, consist of paraffin wax. Particularly suitable are paraffin wax contents (based on the total amount of meltable substance) of approximately 12.5% by weight, approximately 15% by weight or approximately 20% by weight, with special preference possibly being given to even higher proportions, of, for example, more than 30% by weight. In one particular embodiment of the invention, the total amount of the meltable substance used consists exclusively of paraffin wax.

Relative to the other, natural waxes mentioned, paraffin waxes have the advantage in the context of the present invention that in an alkaline cleaning product environment there is no hydrolysis of the waxes (as is to be expected, for example, with the wax esters), since paraffin wax contains no hydrolyzable groups.

Paraffin waxes consist primarily of alkanes, plus low fractions of isoalkanes and cycloalkanes. The paraffin for use in accordance with the invention preferably contains essentially no constituents having a melting point of more than 70° C., with particular preference of more than 60° C. Below this melting temperature in the cleaning product liquor, fractions of high-melting alkanes in the paraffin may leave unwanted wax residues on the surfaces to be cleaned or on the ware to be cleaned. Wax residues of this kind lead in general to an unattractive appearance of the cleaned surface and should therefore be avoided.

Preferred processes are those wherein the core tablet(s) comprises/comprise at least one paraffin wax having a melting range from 30° C. to 65° C.

Preferably, the amount of alkanes, isoalkanes and cycloalkanes which are solid at ambient temperature (generally from about 10 to about 30° C.) in the paraffin wax used is as high as possible. The larger the amount of solid wax constituents in a wax at room temperature, the more useful that wax is in the context of the present invention. As the proportion of solid wax constituents increases, there is an increase in the resistance of the core tablets to impacts or friction on other surfaces, resulting in a longer-lasting protection of the active substances. High proportions of oils or liquid wax constituents may cause weakening, as a result of which pores are opened and the active substances are exposed to the ambient influences mentioned at the outset.

In addition to paraffin, the meltable substance may further comprise one or more of the abovementioned waxes or waxlike substances. Preferably, the mixture forming the meltable substance should be such that the core tablets are at least substantially water-insoluble. At a temperature of about 30° C., the solubility in water should not exceed about 10 mg/l and preferably should be below 5 mg/l.

In any case, however, the material should preferably have as low a solubility in water as possible, even in water at elevated temperature, in order as far as possible to avoid temperature-independent release of the active substances.

The principle described above is used for the delayed release of ingredients at a particular point in time in the cleaning operation and can be employed with particular advantage if washing is carried out in the main wash cycle at a relatively low temperature (for example, 55° C.), so that the active substance is not released from the core tablets until the rinse cycle at higher temperatures (approximately 70° C.).

The abovementioned principle may, however, also be inverted, such that the active substance or substances is or are released from the material not in a retarded manner but, rather, in an accelerated manner. This may be simply achieved by using as meltable substances not dissolution retardants but instead dissolution accelerants, so that the solidified melt dissolves not slowly but quickly instead. In contrast to the dissolution retardants described above, whose solubility in water is poor, preferred dissolution accelerants are readily soluble in water. The water-solubility of the dissolution accelerants may be increased considerably still further by means of certain additives, for example, by incorporation of readily soluble salts or effervescent systems. Dissolution-accelerated meltable substances of this kind (with or without additions of further solubility improvers) lead to rapid release of the enclosed active substances at the beginning of the cleaning operation.

Suitable dissolution accelerants, i.e., meltable substances for the accelerated release of the active substances from the core tablets, are in particular the abovementioned synthetic waxes from the group of polyethylene glycols and polypropylene glycols, so that preferred core tablets comprise at least one substance from the group of the polyethylene glycols (PEGs) and/or polypropylene glycols (PPGs).

Polyethylene glycols (abbreviation PEGs) which can be used in accordance with the invention are polymers of ethylene glycol which satisfy the general formula I

H—(O—CH₂—CH₂)ₙ—OH (I)

in which n is able to adopt values between 1 (ethylene glycol) and over 100,000. Critical in assessing whether a polyethylene glycol may be used in accordance with the invention is the aggregate state of the PEG, i.e., the melting point of the PEG must be above 50° C., so that the monomer (ethylene glycol) and the lower oligomers where n=2 to approximately 10 are not suitable for use, since they have a melting point below 30° C. The polyethylene glycols with higher molecular masses are polymolecular—that is, they consist of collectives of macromolecules having different molecular masses. For polyethylene glycols there exist various nomenclatures, which can lead to confusion. It is common in the art to state the average relative molecular weight after the letters “PEG”, so that “PEG 200” characterizes a polyethylene glycol having a relative molecular mass of from about 190 to about 210. In accordance with this nomenclature, the industrially customary polyethylene glycols PEG 1550, PEG 3000, PEG 4000, and PEG 6000 may be used with preference in the context of the present invention.

For cosmetic ingredients a different nomenclature is used, where the abbreviation PEG is provided with a hyphen and the hyphen is followed directly by a number which corresponds to the number n in the abovementioned formula I. According to this nomenclature (known as the INCI nomenclature, CTFA International Cosmetic Ingredient Dictionary and Handbook, 5th Edition, The Cosmetic, Toiletry and Fragrance Association, Washington, 1997), for example, PEG-32, PEG-40, PEG-55, PEG-60, PEG-75, PEG-100, PEG-150, and PEG-180 may be used with preference in accordance with the invention.

Polyethylene glycols are available commercially, for example, under the trade names Carbowax® PEG 540 (Union Carbide), Emkapol® 6000 (ICI Americas), Lipoxol® 3000 MED (HÜLS America), Polyglycol® E-3350 (Dow Chemical), Lutrol® E4000 (BASF), and the corresponding trade names with higher numbers.

Polypropylene glycols (abbreviation PPGs) which may be used in accordance with the invention are polymers of propylene glycol which satisfy the general formula II

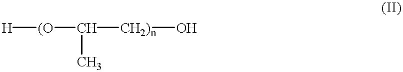

in which n may adopt values of between 1 (propylene glycol) and approximately 1000. As with the above-described PEGs, critical to the evaluation of whether a polypropylene glycol may be used in accordance with the invention is the aggregate state of the PPG, i.e., the melting point of the PPG must be above 30° C., so that the monomer (propylene glycol) and the lower oligomers where n=2 to approximately 10 are not suitable for use since they have a melting point below 30° C.

In addition to the PEGs and PPGs which may be used with preference as dissolution-accelerated meltable substances, it is of course also possible to use other substances provided their solubility in water is sufficiently high and their melting point is above 30° C.

The core tablets produced and used in the process of the invention may—where produced via the melt state—preferably comprise further active substances and/or auxiliaries from the groups of the dyes, fragrances, antisettling agents, suspension agents, antifloating agents, thixotropic agents, and dispersing auxiliaries in amounts of from 0 to 10% by weight, preferably from 0.25 to 7.5% by weight, with particular preference from 0.5 to 5% by weight, and in particular from 0.75 to 2.5% by weight. While fragrances and dyes, as customary ingredients of laundry detergents or cleaning products, are described later on below, the ingredients specific to the core tablets produced by casting in accordance with the invention are described in the following text.

At unusually low temperatures, for example, at temperatures below 0° C., the core tablets might be crushed on impact or friction. In order to improve the stability at such low temperatures, additives may be admixed, if desired, to the meltable substances. Appropriate additives must be completely miscible with the melted wax, must not significantly alter the melting range of the meltable substances, must improve the elasticity of the core tablets at low temperatures, must not generally increase the permeability of the core tablets to water or moisture, and must not increase the viscosity of the melt to such an extent that processing is hindered or even made impossible. Suitable additives which lower the brittleness of a material consisting essentially of paraffin at low temperatures are, for example, EVA copolymers, hydrogenated resin acid methyl esters, polyethylene or copolymers of ethyl acrylate and 2-ethylhexyl acrylate.

It may also be of advantage to add further additives to the meltable substance in order, for example, to prevent premature separation of the mixture in the melt state. The antisettling agents which may be used for this purpose, also referred to as suspension agents, are known from the prior art, for example from the manufacture of paints and printing inks. In order to avoid sedimentation phenomena and concentration gradients of the substances at the transition from the plastic solidification range to the solid state, examples of appropriate substances include surface-active substances, solvent-dispersed waxes, montmorillonites, organically modified bentonites, (hydrogenated) castor oil derivatives, soya lecithin, ethylcellulose, low molecular mass polyamides, metal stearates, calcium soaps, or hydrophobicized silicas. Further substances having said effects originate from the groups of the antifloating agents and the thixotropic agents and may be designated chemically as silicone oils (dimethylpolysiloxanes, methylphenylpolysiloxanes, polyether-modified methyl-alkylpolysiloxanes), oligomeric titanates and silanes, polyamines, salts of long-chain polyamines and polycarboxylic acids, amine/amide-functional polyesters, and amine/amide-functional polyacrylates.

Additives from said classes of substance are available commercially in great diversity. Examples of commercial products which may be used as additives with advantage in the context of the process of the invention are Aerosil® 200 (pyrogenic silica, Degussa), Bentone® SD-1, SD-2, 34, 52 and 57 (bentonite, Rheox), Bentone® SD-3, 27 and 38 (hectorite, Rheox), Tixogel® EZ 100 or VP-A (organically modified smectite, Südchemie), Tixogel® VG, VP and VZ (QAV-loaded montmorillonite, Südchemie), Disperbyk® 161 (block copolymer, Byk-Chemie), Borchigen ND (sulfo-free ion exchanger, Borchers), Ser-Ad® FA 601 (Servo), Solsperse® (aromatic ethoxylate, ICI), Surfynol® grades (Air Products), Tamol® and Triton® grades (Rohm&Haas), Texaphor® 963, 3241 and 3250 (polymers, Henkel), Rilanit® grades (Henkel), Thixcin® E and R (castor oil derivatives, Rheox), Thixatrol® ST and GST (castor oil derivatives, Rheox), Thixatrol® SR, SR 100, TSR and TSR 100 (polyamide polymers, Rheox), Thixatrol® 289 (polyester polymer, Rheox), and the various M-P-A® grades X, 60-X, 1078-X, 2000-X, and 60-MS (organic compounds, Rheox).

Said auxiliaries may be used in varying amounts in the core tablets, depending on the active substance and material used. Customary use concentrations for the abovementioned antisettling, antifloating, thixotropic and dispersing agents are within the range from 0.5 to 8.0% by weight, preferably between 1.0 and 5.0% by weight, and with particular preference between 1.5 and 3.0% by weight, based in each case on the total amount of meltable substance and active substances.

Particularly preferred emulsifiers in the context of the present invention are polyglycerol esters, especially esters of fatty acids with polyglycerols. These preferred polyglycerol esters can be described by the general formula III

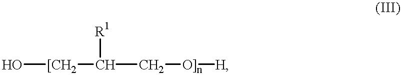

in which R¹ in each glycerol unit independently of one another is H or a fatty acyl radical having 8 to 22 carbon atoms, preferably having 12 to 18 carbon atoms, and n is a number between 2 and 15, preferably between 3 and 10.

These polyglycerol esters are known and commercially available in particular with the degrees of polymerization n=2, 3, 4, 6 and 10. Since substances of the stated type also find broad application in cosmetic formulations, a considerable number of these substances are also classified in the INCI nomenclature (CTFA International Cosmetic Ingredient Dictionary and Handbook, 5th Edition, The Cosmetic, Toiletry and Fragrance Association, Washington, 1997). This standard work of cosmetology includes, for example, information under the headings POLYGLYCERYL-3 BEESWAX, POLYGLYCERYL-3 CETYL ETHER, POLYGLYCERYL-4 COCOATE, POLYGLYCERYL-10 DECALINOLEATE, POLYGLYCERYL-10 DECAOLEATE, POLYGLYCERYL-10 DECASTEARATE, POLYGLYCERYL-2 DIISOSTEARATE, POLYGLYCERYL-3 DIISOSTEARATE, POLYGLYCERYL-10 DIISOSTEARATE, POLYGLYCERYL-2 DIOLEATE, POLYGLYCERYL-3 DIOLEATE, POLYGLYCERYL-6 DIOLEATE, POLYGLYCERYL-10 DIOLEATE, POLYGLYCERYL-3 DISTEARATE, POLYGLYCERYL-6 DISTEARATE, POLYGLYCERYL-10 DISTEARATE, POLYGLYCERYL-10 HEPTAOLEATE, POLYGLYCERYL-12 HYDROXYSTEARATE, POLYGLYCERYL-10 HEPTASTEARATE, POLYGLYCERYL-6 HEXAOLEATE, POLYGLYCERYL-2 ISOSTEARATE, POLYGLYCERYL-4 ISOSTEARATE, POLYGLYCERYL-6 ISOSTEARATE, POLYGLYCERYL-10 LAURATE, POLYGLYCERYL METHACRYLATE, POLYGLYCERYL-10 MYRISTATE, POLYGLYCERYL-2 OLEATE, POLYGLYCERYL-3 OLEATE, POLYGLYCERYL-4 OLEATE, POLYGLYCERYL-6 OLEATE, POLYGLYCERYL-8 OLEATE, POLYGLYCERYL-10 OLEATE, POLYGLYCERYL-6 PENTAOLEATE, POLYGLYCERYL-10 PENTAOLEATE, POLYGLYCERYL-6 PENTASTEARATE, POLYGLYCERYL-10 PENTASTEARATE, POLYGLYCERYL-2 SESQUI-ISOSTEARATE, POLYGLYCERYL-2 SESQUIOLEATE, POLYGLYCERYL-2 STEARATE, POLYGLYCERYL-3 STEARATE, POLYGLYCERYL-4 STEARATE, POLYGLYCERYL-8 STEARATE, POLYGLYCERYL-10 STEARATE, POLYGLYCERYL-2 TETRAISOSTEARATE, POLYGLYCERYL-10 TETRAOLEATE, POLYGLYCERYL-2 TETRASTEARATE, POLYGLYCERYL-2 TRIISOSTEARATE, POLYGLYCERYL-10 TRIOLEATE, POLYGLYCERYL-6 TRISTEARATE. The commercially available products from various manufacturers, which are classified in said work under the above headings, may be used with advantage as emulsifiers in process step b) of the invention.

A further group of emulsifiers which may be used in the core tablets are substituted silicones which carry side chains that have been reacted with ethylene oxide and/or propylene oxide. Such polyoxyalkylenesiloxanes may be described by the general formula IV

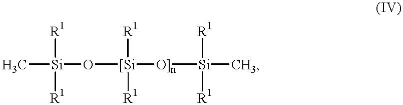

in which each radical R¹ independently of one another is —CH₃ or a polyoxyethylene or polyoxypropylene group —[CH(R²)—CH₂—O]ₓH, R² is —H or —CH₃, x is a number between 1 and 100, preferably between 2 and 20, and in particular below 10, and n indicates the degree of polymerization of the silicone.

Optionally, said polyoxyalkylenesiloxanes may also be etherified or esterified on the free OH groups of the polyoxyethylene and/or polyoxypropylene side chains. The unetherified and unesterified polymer of dimethyl-siloxane with polyoxyethylene and/or polyoxypropylene is referred to in the INCI nomenclature as DIMETHICONE COPOLYOL and is available commercially under the trade names Abil® B (Goldschmidt), Alkasil® (Rhone-Poulenc), Silwet® (Union Carbide) or Belsil® DMC 6031.

The acetic-acid-esterified DIMETHICONE COPOLYOL ACETATE (for example, Belsil® DMC 6032, -33 and -35, Wacker) and DIMETHICONE COPOLYOL BUTYL ETHER (e.g., KF352A, Shin Etsu) are likewise suitable for use as emulsifiers in the context of the present invention.

In the case of the emulsifiers, as already with the meltable substances and the other ingredients, they may be used over a widely varying range. Normally, emulsifiers of the abovementioned type make up from 1 to 25% by weight, preferably from 2 to 20% by weight, and in particular from 5 to 10% by weight, of the weight of the detergent component.

As already mentioned earlier on above, the physical and chemical properties may be varied specifically through a suitable choice of the ingredients of the core tablets. If, for example, only ingredients that are liquid at the melting temperature of the mixture are used, then it is easy to prepare single-phase mixtures, which are notable for particular storage stability even in the molten state. The addition of solids, such as color pigments or substances having higher melting points, for example, leads automatically to two-phase mixtures, which, however, likewise exhibit excellent storage stability and an extremely low propensity to separate.

Independently of the composition of the core tablets produced in step a) of the process of the invention, preference is given to core tablets having a melting point of between 50 and 80° C., preferably between 52.5 and 75° C., and in particular between 55 and 65° C.

In accordance with the invention, however, processing via the melt state in step a) is not tied to casting, i.e., to casting into molds and solidification therein. In accordance with the invention it is also possible to convert melts into core tablets by processing the melt into particulate material by means of appropriate techniques and subsequently compressing these particles to form core tablets. Processes of the invention wherein the core tablets are produced by converting a melt into particulate material and subsequently compressing the particles are therefore further preferred embodiments of the present invention.

When using meltable substances as an ingredient of the core tablets, it is possible to produce particulate preparations by processes which are known per se, which is preferred in the context of the present invention. Particularly appropriate for this purpose are prilling, pelletizing, or flaking.

The process to be used preferably for producing compressible particles, in accordance with the invention, which is referred to for short as prilling, comprises the production of granular elements from meltable substances, the melt comprising the respective ingredients being sprayed in with defined droplet size at the top of a tower, solidifying in free fall, and being obtained as prill granules at the base of the tower.

As the cold gas stream it is possible in very general terms to use all gases, the temperature of the gas being below the melting temperature of the melt. In order to avoid long falling sections, use is frequently made of cooled gases, for example, supercooled air or even liquid nitrogen, which is injected through nozzles into the spray towers.

The particle size of the resulting prills may be varied by way of the choice of droplet size, with particle sizes which are easy to realize technically lying within the range from 0.5 to 2 mm, preferably around 1 mm.

One process variant which is preferred in accordance with the invention therefore envisages producing the core tablets a) by prilling a melt and subsequently compressing the prills.

An alternative process to prilling is pelletizing. A further embodiment of the present invention therefore envisages as a component step a process for preparing pelletized detergent components, which comprises metering a melt onto cooled pelletizing plates.

Pelletizing comprises the metering of the melt comprising the respective ingredients onto a (cooled) belt or onto rotating, inclined plates which have a temperature below the melting temperature of the melt and are preferably cooled to below room temperature. Here again, process variants may be practiced in which the pelletizing plates are supercooled. In this case, however, measures must be taken to counter the condensation of atmospheric moisture.

Pelletizing produces relatively large particles, which in standard industrial processes have sizes of between 2 and 10 mm, preferably between 3 and 6 mm.

Another preferred process variant therefore comprises producing the core tablets a) by pelletizing a melt and subsequently compressing the pellets.

As an even more cost-effective variant for producing particulate detergent components of the stated composition from melts, the use of cooling rolls is appropriate. A further component step of the present invention is therefore a process for preparing particulate detergent components, which comprises applying a melt by spraying or otherwise to a cooling roll, scraping off the solidified melt, and comminuting the scrapings if necessary. The use of cooling rolls permits ready establishment of the desired particle size range, which in this process may also be below 1 mm, for example from 200 to 700 um.

The latter process step, wherein the core tablets a) are produced by flaking a melt and subsequently compressing the flakes, is likewise part of a preferred process variant.

The technical “diversionary route” of producing prills, pellets or flakes and then compressing them into core tablets may be utilized purposively in order to control the disintegration characteristics of the core tablets and so to achieve the controlled release of ingredients.

In the case of core tablets produced as specified, it is possible to provide deliberately for air inclusions, by means of which the particle structure of the finished core tablet is loosened and said tablet more effectively disintegrates into its constituents when the temperature rises in the washing or cleaning operation. A further-preferred process of the invention therefore envisages producing core tablets a) with air inclusions which possess not more than 0.8 times, preferably not more than 0.75 times, and in particular not more than 0.7 times, the mass of a melt body of equal volume and formulation.

By the production of particles from the melt and subsequent compression, tablets are obtained in this way which are notable for a relatively low density. The incorporation of air inclusions can be controlled technically, for example, through the choice of particle size and of particle size distribution. Thus it has been found that premixes with a low free-flowability and low bulk density may be compressed with preference to give “air-rich” core tablets. This may be intensified additionally if the prills, pellets or flakes for compression have a very narrow, preferably monomodal, particle size distribution. Particles which are not spherical may be compressed with particular preference into “air-rich” core tablets in the case of this process variant.

An alternative embodiment of the present invention envisages the core tablet being dissolved only in a retarded manner, for which purpose the disintegration of the core tablet into its constituents is as far as possible to be avoided. To this end, preference is given to processes wherein core tablets a) are produced without substantial air inclusions which possess at least 0.8 times, preferably at least 0.85 times, and in particular at least 0.9 times, the mass of a melt body of equal volume and formulation.

Tablets of this kind may likewise be produced by converting melts into particles and subsequently compressing the particles. In this case it is preferred for the particle mixture for compression to possess a very high bulk density and good free-flowability. Uniform particle shapes (ideally spherical form) and broad particle size distributions are preferred for the production of core tablets which are relatively difficult to dissolve.

Preferred core tablets comprise meltable substances. The composition of particularly preferred core tablets may be described with greater precision. In particularly preferred processes of the invention, at least one core tablet a) has the following composition:

i) from 10 to 89.9% by weight of surfactant(s),

ii) from 10 to 89.9% by weight of meltable substance(s) having a melting point of more than 30° C.,

iii) from 0.1 to 15% by weight of one or more solids,

iv) from 0 to 15% by weight of further active substances and/or auxiliaries.

Alternatively, particularly preferred processes are likewise those wherein at least one core tablet a) has the following composition:

I) from 10 to 90% by weight of surfactant(s),

II) from 10 to 90% by weight of fatty substance(s),

III) from 0 to 70% by weight of meltable substance(s) having a melting point of more than 30° C.,

IV) from 0 to 15% by weight of further active substances and/or auxiliaries.

For extremely preferred core tablets, these quantitative ranges may be limited further. For instance, particularly preferred processes are those wherein the core tablet a) comprises as ingredient i) or I) from 15 to 80, preferably from 20 to 70, with particular preference from 25 to 60, and in particular from 30 to 50% by weight of surfactant(s).

Preferred process variants are also those wherein the tablet a) comprises as ingredient ii) or III) from 15 to 85, preferably from 20 to 80, with particular preference from 25 to 75, and in particular from 30 to 70% by weight of meltable substance(s).

Not least, preference is also given to processes wherein the core tablet a) comprises the ingredient iii) in amounts of from 0.15 to 12.5, preferably from 0.2 to 10, with particular preference from 0.25 to 7.5, and in particular from 0.3 to 5% by weight.

Active substances which are present with particular preference in the core tablet come from the group of the surfactants. Preferred laundry detergent and cleaning product tablets further comprise one or more surfactants. In this context it is possible to use anionic, nonionic, cationic and/or amphoteric surfactants, and/or mixtures thereof. From a performance standpoint, preference is given to mixtures of anionic and nonionic surfactants for laundry detergent tablets and to nonionic surfactants for cleaning product tablets. The total surfactant content of the tablets (based on the end product of the process of the invention) is for laundry detergent tablets from 5 to 60% by weight, based on the tablet weight, preference being given to surfactant contents of more than 15% by weight, while cleaning product tablets for machine dishwashing contain preferably less than 5% by weight of surfactant(s).

Anionic surfactants used are, for example, those of the sulfonate and sulfate type. Preferred surfactants of the sulfonate type are C₉₋₁₃ alkylbenzenesulfonates, olefinsulfonates, i.e., mixtures of alkenesulfonates and hydroxyalkanesulfonates, and also disulfonates, as are obtained, for example, from C₁₂₋₁₈ monoolefins having a terminal or internal double bond by sulfonating with gaseous sulfur trioxide followed by alkaline or acidic hydrolysis of the sulfonation products. Also suitable are alkanesulfonates, which are obtained from C₁₂₋₁₈ alkanes, for example, by sulfochlorination or sulfoxidation with subsequent hydrolysis or neutralization, respectively. Likewise suitable, in addition, are the esters of α-sulfo fatty acids (ester sulfonates), e.g., the α-sulfonated methyl esters of hydrogenated coconut, palm kernel or tallow fatty acids.

Further suitable anionic surfactants are sulfated fatty acid glycerol esters. Fatty acid glycerol esters are the monoesters, diesters and triesters, and mixtures thereof, as obtained in the preparation by esterification of a monoglycerol with from 1 to 3 mol of fatty acid or in the transesterification of triglycerides with from 0.3 to 2 mol of glycerol. Preferred sulfated fatty acid glycerol esters are the sulfation products of saturated fatty acids having 6 to 22 carbon atoms, examples being those of caproic acid, caprylic acid, capric acid, myristic acid, lauric acid, palmitic acid, stearic acid, or behenic acid.

Preferred alk(en)yl sulfates are the alkali metal salts, and especially the sodium salts, of the sulfuric monoesters of C₁₂-C₁₈ fatty alcohols, examples being those of coconut fatty alcohol, tallow fatty alcohol, lauryl, myristyl, cetyl or stearyl alcohol, or of C_{10-C}₂₀ oxo alcohols, and those monoesters of secondary alcohols of these chain lengths. Preference is also given to alk(en)yl sulfates of said chain length which contain a synthetic straight-chain alkyl radical prepared on a petrochemical basis, these sulfates possessing degradation properties similar to those of the corresponding compounds based on fatty-chemical raw materials. From a detergents standpoint, the C₁₂-C₁₆ alkyl sulfates and C₁₂-C₁₅ alkyl sulfates, and also C₁₄-C₁₅ alkyl sulfates, are preferred. In addition, 2,3-alkyl sulfates, which may for example be prepared in accordance with U.S. Pat. Nos. 3,234,258 or 5,075,041 and obtained as commercial products from Shell Oil Company under the name DAN®, are suitable anionic surfactants.

Also suitable are the sulfuric monoesters of the straight-chain or branched C₇₋₂₁ alcohols ethoxylated with from 1 to 6 mol of ethylene oxide, such as 2-methyl-branched C₉₋₁₁ alcohols containing on average 3.5 mol of ethylene oxide (EO) or C₁₂₋₁₈ fatty alcohols containing from 1 to 4 EO. Because of their high foaming behavior they are used in cleaning products only in relatively small amounts, for example, in amounts of from 1 to 5% by weight.

Further suitable anionic surfactants include the salts of alkylsulfosuccinic acid, which are also referred to as sulfosuccinates or as sulfosuccinic esters and which constitute monoesters and/or diesters of sulfosuccinic acid with alcohols, preferably fatty alcohols and especially ethoxylated fatty alcohols. Preferred sulfosuccinates comprise C8-18 fatty alcohol radicals or mixtures thereof. Especially preferred sulfosuccinates contain a fatty alcohol radical derived from ethoxylated fatty alcohols which themselves represent nonionic surfactants (for description, see below). Particular preference is given in turn to sulfosuccinates whose fatty alcohol radicals are derived from ethoxylated fatty alcohols having a narrowed homolog distribution. Similarly, it is also possible to use alk(en)ylsuccinic acid containing preferably 8 to 18 carbon atoms in the alk(en)yl chain, or salts thereof.

Further suitable anionic surfactants are, in particular, soaps. Suitable soaps include saturated fatty acid soaps, such as the salts of lauric acid, myristic acid, palmitic acid, stearic acid, hydrogenated erucic acid and behenic acid, and, in particular, mixtures of soaps derived from natural fatty acids, e.g., coconut, palm kernel, or tallow fatty acids.

The anionic surfactants, including the soaps, may be present in the form of their sodium, potassium or ammonium salts and also as soluble salts of organic bases, such as mono-, di- or triethanolamine. Preferably, the anionic surfactants are in the form of their sodium or potassium salts, in particular in the form of the sodium salts.

Nonionic surfactants used are preferably alkoxylated, advantageously ethoxylated, especially primary, alcohols having preferably 8 to 18 carbon atoms and on average from 1 to 12 mol of ethylene oxide (EO) per mole of alcohol, in which the alcohol radical may be linear or, preferably, methyl-branched in position 2 and/or may comprise linear and methyl-branched radicals in a mixture, as are commonly present in oxo alcohol radicals. In particular, however, preference is given to alcohol ethoxylates containing linear radicals from alcohols of natural origin having 12 to 18 carbon atoms, e.g., from coconut, palm, tallow fatty or oleyl alcohol, and on average from 2 to 8 EO per mole of alcohol. Preferred ethoxylated alcohols include, for example, C₁₂-₁₄ alcohols containing 3 EO or 4 EO, C₉₋₁₁ alcohol containing 7 EO, C₁₃₋₁₅ alcohols containing 3 EO, 5 EO, 7 EO or 8 EO, C₁₂₋₁₈ alcohols containing 3 EO, 5 EO or 7 EO, and mixtures thereof, such as mixtures of C₁₂₋₁₄ alcohol containing 3 EO and C₁₂₋₁₈ alcohol containing 5 EO. The stated degrees of ethoxylation represent statistical mean values, which for a specific product may be an integer or a fraction. Preferred alcohol ethoxylates have a narrowed homolog distribution (narrow range ethoxylates, NREs). In addition to these nonionic surfactants it is also possible to use fatty alcohols containing more than 12 EO. Examples thereof are tallow fatty alcohol containing 14 EO, 25 EO, 30 EO or 40 EO.

As further nonionic surfactants, furthermore, use may also be made of alkyl glycosides of the general formula RO(G)ₓ, where R is a primary straight-chain or methyl-branched aliphatic radical, especially an aliphatic radical methyl-branched in position 2, containing 8 to 22, preferably 12 to 18, carbon atoms, and G is the symbol representing a glycose unit having 5 or 6 carbon atoms, preferably glucose. The degree of oligomerization, x, which indicates the distribution of monoglycosides and oligoglycosides, is any desired number between 1 and 10; preferably, x is from 1.2 to 1.4.

A further class of nonionic surfactants used with preference, which are used either as sole nonionic surfactant or in combination with other nonionic surfactants, are alkoxylated, preferably ethoxylated, or ethoxylated and propoxylated, fatty acid alkyl esters, preferably having 1 to 4 carbon atoms in the alkyl chain, especially fatty acid methyl esters.

Nonionic surfactants of the amine oxide type, examples being N-cocoalkyl-N,N-dimethylamine oxide and N-tallowalkyl-N,N-dihydroxyethylamine oxide, and of the fatty acid alkanolamide type, may also be suitable. The amount of these nonionic surfactants is preferably not more than that of the ethoxylated fatty alcohols, in particular not more than half thereof.

Further suitable surfactants are polyhydroxy fatty acid amides of the formula (V)

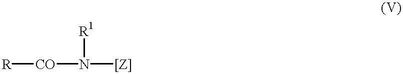

where RCO is an aliphatic acyl radical having 6 to 22 carbon atoms, R¹ is hydrogen or an alkyl or hydroxyalkyl radical having 1 to 4 carbon atoms, and [Z] is a linear or branched polyhydroxyalkyl radical having 3 to 10 carbon atoms and from 3 to 10 hydroxyl groups. The polyhydroxy fatty acid amides are known substances which are customarily obtainable by reductive amination of a reducing sugar with ammonia, an alkylamine or an alkanolamine, and subsequent acylation with a fatty acid, a fatty acid alkyl ester or a fatty acid chloride.

The group of the polyhydroxy fatty acid amides also includes compounds of the formula (VI)

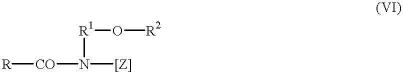

where R is a linear or branched alkyl or alkenyl radical having 7 to 12 carbon atoms, R¹ is a linear, branched or cyclic alkyl radical or an aryl radical having 2 to 8 carbon atoms and R² is a linear, branched or cyclic alkyl radical or an aryl radical or an oxyalkyl radical having 1 to 8 carbon atoms, preference being given to C₁₋₄ alkyl radicals or phenyl radicals, and [Z] is a linear polyhydroxyalkyl radical whose alkyl chain is substituted by at least two hydroxyl groups, or alkoxylated, preferably ethoxylated or propoxylated, derivatives of said radical.

[Z] is preferably obtained by reductive amination of a reduced sugar, e.g., glucose, fructose, maltose, lactose, galactose, mannose, or xylose. The N-alkoxy- or N-aryloxy-substituted compounds may then be converted to the desired polyhydroxy fatty acid amides, by reaction with fatty acid methyl esters in the presence of an alkoxide as catalyst.

In the context of the present invention, preference is given to processes wherein the core tablet a) comprises as ingredient i) or I) anionic and/or nonionic surfactant(s), preferably nonionic surfactant(s); performance advantages may result from certain proportions in which the individual classes of surfactant are used.

Particular preference is given to processes of the invention wherein the core tablet(s) comprises/comprise a nonionic surfactant having a melting point above room temperature. Accordingly, in preferred processes of the invention the core tablet a) comprises as ingredient i) or I) nonionic surfactant(s) having a melting point of more than 20° C., preferably more than 25° C., with particular preference between 25 and 60° C., and in particular between 26.6 and 43.3° C.

Suitable nonionic surfactants having melting or softening points within the stated temperature range are, for example, low-foaming nonionic surfactants which may be solid or highly viscous at room temperature. If nonionic surfactants which are highly viscous at room temperature are used, then it is preferred that they have a viscosity above 20 Pas, preferably above 35 Pas, and in particular above 40 Pas. Also preferred are nonionic surfactants which possess a waxlike consistency at room temperature.

Preferred nonionic surfactants for use that are solid at room temperature originate from the groups of alkoxylated nonionic surfactants, especially the ethoxylated primary alcohols, and mixtures of these surfactants with surfactants of more complex construction such as polyoxypropylene/polyoxyethylene/polyoxypropylene (PO/EO/PO) surfactants. Such (PO/EO/PO) nonionic surfactants are notable, furthermore, for good foam control.

In one preferred embodiment of the present invention, the nonionic surfactant having a melting point above room temperature is an ethoxylated nonionic surfactant originating from the reaction of a monohydroxy alkanol or alkylphenol having 6 to 20 carbon atoms with preferably at least 12 mol, with particular preference at least 15 mol, in particular at least 20 mol, of ethylene oxide per mole of alcohol or alkylphenol, respectively.

A particularly preferred nonionic surfactant for use that is solid at room temperature is obtained from a straight-chain fatty alcohol having 16 to 20 carbon atoms (C₁₆₋₂₀ alcohol), preferably a C₁₈ alcohol, and at least 12 mol, preferably at least 15 mol, and in particular at least 20 mol of ethylene oxide. Of these, the so-called “narrow range ethoxylates” (see above) are particularly preferred.

Accordingly, particularly preferred processes of the invention are those wherein the core tablet a) comprises as ingredient i) or I) ethoxylated nonionic surfactant(s) obtained from C₆₋₂₀ monohydroxyalkanols or C₆₋₂₀ alkylphenols or C₁₆₋₂₀ fatty alcohols and more than 12 mol, preferably more than 15 mol, and in particular more than 20 mol, of ethylene oxide per mole of alcohol.

The nonionic surfactant which is solid at room temperature preferably further possesses propylene oxide units in the molecule. Preferably, such PO units account for up to 25% by weight, with particular preference up to 20% by weight, and in particular up to 15% by weight, of the overall molar mass of the nonionic surfactant. Particularly preferred nonionic surfactants are ethoxylated monohydroxy alkanols or alkylphenols, which additionally comprise polyoxyethylene-polyoxypropylene block copolymer units. The alcohol or alkylphenol moiety of such nonionic surfactant molecules in this case makes up preferably more than 30% by weight, with particular preference more than 50% by weight, and in particular more than 70% by weight, of the overall molecular mass of such nonionic surfactants. Preferred processes are those wherein the core tablet a) comprises as ingredient i) or I) ethoxylated and propoxylated nonionic surfactants in which the propylene oxide units in the molecule account for up to 25% by weight, preferably up to 20% by weight, and in particular up to 15% by weight, of the overall molecular mass of the nonionic surfactant.

Further nonionic surfactants whose use is particularly preferred, having melting points above room temperature, contain from 40 to 70% of a polyoxypropylene/polyoxyethylene/polyoxypropylene block polymer blend which comprises 75% by weight of an inverted block copolymer of polyoxyethylene and polyoxypropylene containing 17 mol of ethylene oxide and 44 mol of propylene oxide and 25% by weight of a block copolymer of polyoxyethylene and polyoxypropylene, initiated with trimethylolpropane and containing 24 mol of ethylene oxide and 99 mol of propylene oxide per mole of trimethylolpropane.

Nonionic surfactants which may be used with particular preference are, for example, obtainable under the name Poly Tergent® SLF-18 from the company Olin Chemicals.

A further preferred process of the invention is that wherein the core tablet a) comprises as ingredient i) or I) nonionic surfactants of the formula

R¹O[CH₂CH (CH₃)O]ₓ[CH₂CH₂O]_{y[CH}₂CH(OH)R²]

in which R¹ is a linear or branched aliphatic hydrocarbon radical having 4 to 18 carbon atoms, or mixtures thereof, R² is a linear or branched hydrocarbon radical having 2 to 26 carbon atoms, or mixtures thereof, x is between 0.5 and 1.5, and y is at least 15.

Further nonionic surfactants which may be used with preference are the endgroup-capped poly(oxyalkylated) nonionic surfactants of the formula

R¹O[CH₂CH(R³)O]ₓ[CH₂]ₖCH(OH)[CH₂]ⱼOR²

in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is between 1 and 30, k and j are between 1 and 12, preferably between 1 and 5. Where x≧2, each R³ in the above formula may be different. R¹ and R² are preferably linear or branched, saturated or unsaturated, aliphatic or aromatic hydrocarbon radicals having 6 to 22 carbon atoms, radicals having 8 to 18 carbon atoms being particularly preferred. For the radical R³, H, —CH₃ or —CH₂CH₃ are particularly preferred. Particularly preferred values for x lie within the range from 1 to 20, in particular from 6 to 15.

As described above, each R³ in the above formula may be different if x≧2. By this means it is possible to vary the alkylene oxide unit in the square brackets. If x, for example, is 3, the radical R³ may be selected in order to form ethylene oxide (R³=H), or propylene oxide (R³=CH₃) units, which may be added on to one another in any sequence, examples being (EO) (PO) (EO), (EO)(EO) (PO), (EO)(EO)(EO), (PO) (EO)(PO), (PO)(PO) (EO) and (PO) (PO) (PO). The value of 3 for x has been chosen by way of example in this case and it is entirely possible for it to be larger, the scope for variation increasing as the values of x go up and embracing, for example, a large number of (EO) groups, combined with a small number of (PO) groups, or vice versa.

Particularly preferred endgroup-capped poly(oxyalkylated) alcohols of the above formula have values of k=1 and j1, thereby simplifying the above formula to

R¹O[CH₂CH(R³)O]ₓCH₂CH(OH)CH₂OR²

In the last-mentioned formula, R¹, R² and R³ are as defined above and x is from 1 to 30, preferably from 1 to 20, and in particular from 6 to 18. Particular preference is given to surfactants wherein the radicals R¹ and R² have 9 to 14 carbon atoms, R³ is H, and x adopts values from 6 to 15.

Summarizing the last-mentioned statements, preference is given to processes of the invention wherein the core tablet a) comprises as ingredient i) or I) endgroup-capped poly(oxyalkylated) nonionic surfactants of the formula

R¹O[CH₂CH(R³)O]ₓ[CH₂]ₖCH(OH)[CH₂]ⱼOR²

in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is between 1 and 30, k and j are between 1 and 12, preferably between 1 and 5, particular preference being given to surfactants of the type

R¹O [CH₂CH (R³)O]ₓCH₂CH(OH)CH₂OR²

where x is from 1 to 30, preferably from 1 to 20, and in particular from 6 to 18.

In the process of the invention, the core tablets a) may comprise further ingredients, with preferred processes being those wherein the core tablet a) comprises as ingredient II) from 12.5 to 85, preferably from 15 to 80, with particular preference from 17.5 to 75, and in particular from 20 to 70% by weight of fatty substance(s).

In the context of this specification, fatty substances are substances which at standard temperature (20° C.) are liquid to solid and come from the group of the fatty alcohols, fatty acids and fatty acid derivatives, especially the fatty acid esters. Reaction products of fatty alcohols with alkylene oxides, and the salts of fatty acids, are included for the purposes of the present specification among the surfactants (see above) and are not fatty substances in the sense of the invention. Fatty substances which may be used with preference in accordance with the invention are fatty alcohols and fatty alcohol mixtures, fatty acids and fatty acid mixtures, fatty acid esters with alkanols and/or diols and/or polyols, fatty acid amides, fatty amines, etc.

Preferred processes are those wherein the core tablet a) comprises as ingredient II) one or more substances from the groups of the fatty alcohols, fatty acids, and fatty acid esters.

Fatty alcohols used are, for example, the alcohols obtainable from natural fats and oils: 1-hexanol (caproyl alcohol), 1-heptanol (enanthyl alcohol), 1-octanol (capryl alcohol), 1-nonanol (pelargonyl alcohol), 1-decanol (capric alcohol), 1-undecanol, 10-undecen-l-ol, 1-dodecanol (lauryl alcohol), 1-tridecanol, 1-tetradecanol (myristyl alcohol), 1-pentadecanol, 1-hexadecanol (cetyl alcohol), 1-heptadecanol, 1-octadecanol (stearyl alcohol), 9-cis-octadecen-1-ol (oleyl alcohol), 9-trans-octadecen-1-ol (erucyl alcohol), 9-cis-octadecene-1,12-diol (ricinolyl alcohol), all-cis-9,12-octadecadien-1-ol (linoleyl alcohol), all-cis-9,12,15-octadecatrien-1-ol (linolenyl alcohol), 1-nonadecanol, 1-eicosanol (arachidyl alcohol), 9-cis-eicosen-1-ol (gadoleyl alcohol), 5,8,11,14-eicosatetraen-1-ol, 1-heneicosanol, 1-docosanol (behenyl alcohol), 1-3-cis-docosen-1-ol (erucyl alcohol), 1-3-trans-docosen-1-ol (brassidyl alcohol), and mixtures of these alcohols. In accordance with the invention, guerbet alcohols and oxo alcohols, for example, C₁₃₋₁₅ oxo alcohols or mixtures of C₁₂₋₁₈ alcohols with C₁₂₋₁₄ alcohols can also be used without problems as fatty substances. However, it is of course also possible to use alcohol mixtures, for example those such as the C₁₆₋₁₈ alcohols prepared by Ziegler ethylene polymerization. Specific examples of alcohols which may be used as component b) are the alcohols already mentioned above and also lauryl alcohol, palmityl alcohol and stearyl alcohol, and mixtures thereof.

In particularly preferred processes of the invention the core tablet a) comprises as ingredient II) one or more C₁₀₋₃₀ fatty alcohols, preferably C₁₂₋₂₄ fatty alcohols, with particular preference 1-hexadecanol, 1-octadecanol, 9-cis-octadecen-l-ol, all-cis-9,12-octadecadien-1-ol, all-cis-9,12,15-octadecatrien-1-ol, 1-docosanol, and mixtures thereof.

As the fatty substance it is also possible to use fatty acids. Industrially, these are obtained primarily from natural fats and oils by hydrolysis. Whereas the alkaline saponification, conducted as long ago as the 19^{th} century, led directly to the alkali metal salts (soaps), nowadays only water is used industrially to cleave the fats into glycerol and the free fatty acids. Examples of processes employed industrially are cleavage in an autoclave or continuous high-pressure cleavage. Carboxylic acids which may be used as fatty substances in the context of the present invention are, for example, hexanoic acid (caproic acid), heptanoic acid (enanthic acid), octanoic acid (caprylic acid), nonanoic acid (pelargonic acid), decanoic acid (capric acid), undecanoic acid etc. Preference is given in the context of the present invention to the use of fatty acids such as dodecanoic acid (lauric acid), tetradecanoic acid (myristic acid), hexadecanoic acid (palmitic acid), octadecanoic acid (stearic acid), eicosanoic acid (arachidic acid), docosanoic acid (behenic acid), tetracosanoic acid (lignoceric acid), hexacosanoic acid (cerotic acid), triacontanoic acid (melissic acid) and also the unsaturated species 9c-hexadecenoic acid (palmitoleic acid), 6c-octadecenoic acid (petroselinic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienoic acid (linolaidic acid), and 9c,12c,15c-octadecatrienoic acid (linolenic acid). Also possible for use, of course, are tridecanoic acid, pentadecanoic acid, margaric acid, nonadecanoic acid, erucic acid, eleostearic acid, and arachidonic acid. For reasons of cost it is preferred to use not the pure species but rather technical-grade mixtures of the individual acids, as obtainable from fat cleavage. Such mixtures are, for example, coconut oil fatty acid (approximately 6% by weight C₈, 6% by weight C₁₀, 48% by weight C₁₂, 18% by weight C₁₄, 10% by weight C₁₆, 2% by weight C₁₈, 8% by weight C₁₈, 1% by weight C₁₈), palm kernel oil fatty acid (approximately 4% by weight C₈, 5% by weight C₁₀, 50% by weight C₁₂, 15% by weight C₁₄, 7% by weight C₁₆, 2% by weight C₁₈, 15% by weight C_{18′}, 1% by weight C_{18″}), tallow fatty acid (approximately 3% by weight C₁₄, 26% by weight C₁₆, 2% by weight C_{16′}, 2% by weight C₁₇, 17% by weight C₁₈, 44% by weight C_{18′}, 3% by weight C₁₈, 1% by weight C_{18′″}), hardened tallow fatty acid (approximately 2% by weight C₁₄, 28% by weight C₁₆, 2% by weight C₁₇, 63% by weight C₁₈, 1% by weight C_{18′}), technical-grade oleic acid (approximately 1% by weight C₁₂, 3% by weight C₁₄, 5% by weight C₁₆, 6% by weight C_{16′}, 1% by weight C₁₇, 2% by weight C₁₈, 70% by weight C_{18′}, 10% by weight C₁₈, 0.5% by weight C_{18′″}), technical-grade palmitic/stearic acid (approximately 1% by weight C₁₂, 2% by weight C₁₄, 45% by weight C₁₆, 2% by weight C₁₇, 47% by weight C₁₈, 1% by weight C_{18′}), and soybean oil fatty acid (approximately 2% by weight C₁₄, 15% by weight C₁₆, 5% by weight C₁₈, 25% by weight C₁₈, 18′, 45% by weight C_{18″}, 7% by weight C_{18′″}).

As fatty acid esters, use may be made of the esters of fatty acids with alkanols, diols or polyols, fatty acid polyol esters being preferred. Suitable fatty acid polyol esters include monoesters and diesters of fatty acids with certain polyols. The fatty acids that are esterified with the polyols are preferably saturated or unsaturated fatty acids of 12 to 18 carbon atoms, examples being lauric acid, myristic acid, palmitic acid, and stearic acid, preference being given to the use of the fatty acid mixtures obtained industrially, for example, the acid mixtures derived from coconut oil, palm kernel oil or tallow fat. In particular, acids or mixtures of acids having 16 to 18 carbon atoms, such as tallow fatty acid, for example, are suitable for esterification with the polyhydric alcohols. In the context of the present invention, suitable polyols for esterification with the aforementioned fatty acids include sorbitol, trimethylolpropane, neopentyl glycol, ethylene glycol, polyethylene glycols, glycerol, and polyglycerols.

Preferred embodiments of the present invention provide for the polyol esterified with fatty acid(s) to be glycerol. Accordingly, preference is given to detergent components of the invention comprising as ingredient b) one or more fatty substances from the group consisting of fatty alcohols and fatty acid glycerides. Particularly preferred detergent components comprise as component b) a fatty substance from the group consisting of the fatty alcohols and fatty acid monoglycerides. Examples of such fatty substances used with preference are glyceryl monostearate and glyceryl monopalmitate.

Processes wherein the core tablet a) comprises as ingredient ii) or III) one or more substances having a melting range between 30 and 100° C., preferably between 40 and 80° C., and in particular between 50 and 75° C., are particularly preferred in accordance with the invention. The corresponding classes of substance have been described in detail earlier on above. Particular preference is given in this context to processes wherein the core tablet a) comprises as ingredient ii) or III) at least one paraffin wax having a melting range of from 30° C. to 65° C.

In the case of dissolution-accelerated core tablets, preferred processes of the invention are those wherein the core tablet a) comprises as ingredient ii) or III) at least one substance from the group consisting of polyethylene glycols (PEGs) and/or polypropylene glycols (PPGs). The representatives of these classes of substance have also been described in detail earlier on above.

As further ingredients, the preferred core tablets may comprise additional active substances and auxiliaries. Processes wherein the core tablet a) comprises as ingredient iv) or IV) further active substances and/or auxiliaries from the groups consisting of dyes, fragrances, antisettling agents, suspension agents, antifloating agents, thixotropic agents and dispersing auxiliaries in amounts of from 0 to 10% by weight, preferably from 0.25 to 7.5% by weight, with particular preference from 0.5 to 5% by weight, and in particular from 0.75 to 2.5% by weight, are preferred in this context.

Irrespective of the ingredients used and of the method of production of the core tablets, preference is given to processes of the invention wherein the core tablet a) has a melting point of between 50 and 80° C., preferably between 52.5 and 75° C., and in particular between 55 and 65° C.

As already mentioned a number of times, both two or more core tablets and two or more premixes may be compressed to form the end products of the process of the invention by performing step e) of the process of the invention—the optional repetition of steps c) and d). Independently of whether the base tablet comprises one or more phases and independently of the number of core tablets present in the process end products, preference is given to processes wherein the weight ratio of overall tablet to the sum of the masses of all core tablets present in the tablet is in the range from 1:1 to 100:1, preferably from 2:1 to 80:1, with particular preference from 3:1 to 50:1, and in particular from 4:1 to 30:1.

Particular possibilities for visual differentiation are provided if at least one core tablet is visible from the outside. Corresponding processes of the invention wherein the surface of at least one core tablet is visible from the outside and the sum of all visible surfaces of all core tablets present in the tablet makes up from 1 to 80%, preferably from 5 to 65%, with particular preference from 10 to 50%, and in particular from 15 to 40%, of the overall surface area of the tablet, are preferred.

Similar comments may also be made regarding the volumes occupied by the core tablet(s) in comparison to the overall volume of the process end product. Here, preference is given to processes wherein the volume of all core tablets present in the tablet makes up from 1 to 60%, preferably from 2.5 to 50%, with particular preference 5 to 40%, and in particular from 7.5 to 30%, of the overall volume of the tablet.

Finally, preferred processes are those wherein the height of the tablets produced in step a) makes up from 10 to 50%, preferably from 15 to 45%, with particular preference from 20 to 40%, and in particular from 25 to 35%, of the overall height of the tablet.

The core tablet(s) and the premix(es) are preferably colored so as to be visually distinguishable. In addition to the visual differentiation, it is possible to achieve performance advantages by means of different solubilities of the different tablet regions. For instance, preferred processes of the invention are those wherein at least one core tablet dissolves more rapidly than the base tablet. On the other hand, preference is also given to processes wherein at least one core tablet dissolves more slowly than the base tablet. By incorporating certain constituents it is possible on the one hand to accelerate the solubility of the core tablets in a targeted manner; on the other hand, the release of certain ingredients from the core tablet may lead to advantages in the washing or cleaning process. Ingredients which are preferably located at least in part in the core tablet are, for example, the below-described disintegration aids, surfactants, enzymes, soil release polymers, builders, bleaches, bleach activators, bleaching catalysts, optical brighteners, silver protectants, etc.

There now follows a description of the preferred ingredients of the end products of the process of the invention.

Laundry detergent and cleaning product tablets which are preferred in the context of the present invention comprise builders in amounts of from 1 to 100% by weight, preferably from 5 to 95% by weight, with particular preference from 10 to 90% by weight, and in particular from 20 to 85% by weight, based in each case on the weight of the overall tablet.

In the laundry detergent and cleaning product tablets produced in accordance with the invention it is possible for all builders commonly used in laundry detergents and cleaning products to be present, i.e., in particular, zeolites, silicates, carbonates, organic cobuilders, and—where there are no ecological prejudices against their use—the phosphates as well.

Suitable crystalline, layered sodium silicates possess the general formula NaMSiₓO₂+1.yH₂O, where M is sodium or hydrogen, x is a number from 1.9 to 4, y is a number from 0 to 20, and preferred values for x are 2, 3 or 4. Preferred crystalline phyllosilicates of the formula indicated are those in which M is sodium and x adopts the value 2 or 3. In particular, both β- and δ-sodium disilicates Na₂Si₂O₅.yH₂O are preferred.

It is also possible to use amorphous sodium silicates having an Na₂O:SiO₂ modulus of from 1:2 to 1:3.3, preferably from 1:2 to 1:2.8, and in particular from 1:2 to 1:2.6, which are dissolution-retarded and have secondary washing properties. The retardation of dissolution relative to conventional amorphous sodium silicates may have been brought about in a variety of ways—for example, by surface treatment, compounding, compacting, or overdrying. In the context of this invention, the term “amorphous” also embraces “X-ray-amorphous”. This means that in X-ray diffraction experiments the silicates do not yield the sharp X-ray reflections typical of crystalline substances but instead yield at best one or more maxima of the scattered X-radiation, having a width of several degree units of the diffraction angle. However, good builder properties may result, even particularly good builder properties, if the silicate particles in electron diffraction experiments yield vague or even sharp diffraction maxima. The interpretation of this is that the products have microcrystalline regions with a size of from 10 to several hundred nm, values up to max. 50 nm and in particular up to max. 20 nm being preferred. Particular preference is given to compacted amorphous silicates, compounded amorphous silicates, and overdried X-ray-amorphous silicates.

In the context of the present invention, laundry detergent and cleaning product tablets which are preferably produced by the process of the invention are those which comprise silicate(s), preferably alkali metal silicates, with particular preference crystalline or amorphous alkali metal disilicates, in amounts of from 10 to 60% by weight, preferably from 15 to 50% by weight, and in particular from 20 to 40% by weight, based in each case on the weight of the tablet.

The finely crystalline, synthetic zeolite used, containing bound water, is preferably zeolite A and/or P. A particularly preferred zeolite P is Zeolite MAP® (commercial product from Crosfield). Also suitable, however, are zeolite X and also mixtures of A, X and/or P. A product available commercially and able to be used with preference in the context of the present invention, for example, is a cocrystallizate of zeolite X and zeolite A (approximately 80% by weight zeolite X), which is sold by CONDEA Augusta S.p.A. under the brand name VEGOBOND AX® and may be described by the formula

nNa₂O.(1−n)K₂O.Al₂O₃.(2−2.5) SiO₂.(3.5−5.5)H₂O.

The zeolite may be used either as a builder in a granular compound or as a kind of “powdering” for the entire mixture intended for compression, it being common to utilize both methods for incorporating the zeolite into the premix. Suitable zeolites have an average particle size of less than 10 μm (volume distribution; measurement method: Coulter counter) and contain preferably from 18 to 22% by weight, in particular from 20 to 22% by weight, of bound water.

Of course, the widely known phosphates may also be used as builder substances provided such a use is not to be avoided on ecological grounds. Among the large number of commercially available phosphates, the alkali metal phosphates, with particular preference being given to pentasodium and pentapotassium triphosphate (sodium and potassium tripolyphosphate, respectively), possess the greatest importance in the laundry detergent and cleaning product industry.

Alkali metal phosphates is the collective term for the alkali metal (especially sodium and potassium) salts of the various phosphoric acids, among which meta-phosphoric acids (HPO₃)ₙ and orthophosphoric acid H₃PO₄, in addition to higher-molecular-mass representatives, may be distinguished. The phosphates combine a number of advantages: they act as alkali carriers, prevent limescale deposits on machine components, and lime incrustations on fabrics, and additionally contribute to cleaning performance.

Sodium dihydrogen phosphate, NaH₂PO₄, exists as the dihydrate (density 1.91 g cm⁻³ melting point 60°) and as the monohydrate (density 2.04 g cm⁻³). Both salts are white powders which are very readily soluble in water and which lose the water of crystallization on heating and undergo conversion at 200° C. into the weakly acidic diphosphate (disodium dihydrogen diphosphate, Na₂H₂P₂O₇) and at a higher temperature into sodium trimetaphosphate (Na₃P₃O₉) and Maddrell's salt (see below). NaH₂PO₄ reacts acidically; it is formed if phosphoric acid is adjusted to a pH of 4.5 using sodium hydroxide solution and the slurry is sprayed. Potassium dihydrogen phosphate (primary or monobasic potassium phosphate, potassium biphosphate, PDP), KH₂PO₄, is a white salt with a density of 2.33 g cm⁻³, has a melting point of 253° [decomposition with formation of potassium polyphosphate (KPO₃)ₓ], and is readily soluble in water.

Disodium hydrogen phosphate (secondary sodium phosphate), Na₂HPO₄, is a colorless, crystalline salt which is very readily soluble in water. It exists in anhydrous form and with 2 mol (density 2.066 g cm⁻³, water loss at 95°), 7 mol (density 1.68 g cm⁻³, melting point 48° with loss of 5 H₂O), and 12 mol of water (density 1.52 g cm⁻³, melting point 35° with loss of 5 H₂O), becomes anhydrous at 100° , and if heated more severely undergoes transition to the diphosphate Na₄P₂O₇. Disodium hydrogen phosphate is prepared by neutralizing phosphoric acid with sodium carbonate solution using phenolphthalein as indicator. Dipotassium hydrogen phosphate (secondary or dibasic potassium phosphate), K₂HPO₄, is an amorphous white salt which is readily soluble in water.

Trisodium phosphate, tertiary sodium phosphate, Na₃PO₄, exists as colorless crystals which as the dodecahydrate have a density of 1.62 g cm⁻³ and a melting point of 73-76° C. (decomposition), as the decahydrate (corresponding to 19-20% P₂O₅) have a melting point of 100° C., and in anhydrous form (corresponding to 39-40% P₂O₅) have a density of 2.536 g cm⁻³. Trisodium phosphate is readily soluble in water, with an alkaline reaction, and is prepared by evaporative concentration of a solution of precisely 1 mol of disodium phosphate and 1 mol of NaOH. Tripotassium phosphate (tertiary or tribasic potassium phosphate), K₃PO₄, is a white, deliquescent, granular powder of density 2.56 g cm⁻³, has a melting point of 1340°, and is readily soluble in water with an alkaline reaction. It is produced, for example, when Thomas slag is heated with charcoal and potassium sulfate. Despite the relatively high price, the more readily soluble and therefore highly active potassium phosphates are frequently preferred in the cleaning products industry over the corresponding sodium compounds.

Tetrasodium diphosphate (sodium pyrophosphate), Na₄P₂O₇, exists in anhydrous form (density 2.534 g cm⁻³, melting point 988°, 880° also reported) and as the decahydrate (density 1.815-1.836 g cm⁻³, melting point 94° with loss of water). Both substances are colorless crystals which dissolve in water with an alkaline reaction. Na₄P₂O₇ is formed when disodium phosphate is heated at >200° or by reacting phosphoric acid with sodium carbonate in stoichiometric ratio and dewatering the solution by spraying. The decahydrate complexes heavy metal salts and water hardeners and therefore reduces the hardness of the water. Potassium diphosphate (potassium pyrophosphate), K₄P₂O₇, exists in the form of the trihydrate and is a colorless, hygroscopic powder of density 2.33 g cm⁻³ which is soluble in water, the pH of the 1% strength solution at 25° being 10.4.

Condensation of NaH₂PO₄ or of KH₂PO₄ gives rise to higher-molecular-mass sodium and potassium phosphates, among which it is possible to distinguish cyclic representatives, the sodium and potassium metaphosphates, and catenated types, the sodium and potassium polyphosphates. For the latter in particular a large number of names are in use: fused or calcined phosphates, Graham's salt, Kurrol's and Maddrell's salt. All higher sodium and potassium phosphates are referred to collectively as condensed phosphates.

The industrially important pentasodium triphosphate, Na₅P₃O₁₀ (sodium tripolyphosphate), is a nonhygroscopic, white, water-soluble salt which is anhydrous or crystallizes with 6 H₂O and has the general formula NaO—[P(O)(ONa)—O]ₙ—Na where n=3. About 17 g of the anhydrous salt dissolve in 100 g of water at room temperature, at 60° about 20 g, at 100° around 32 g; after heating the solution at 100° C. for two hours, about 8% orthophosphate and 15% diphosphate are produced by hydrolysis. For the preparation of pentasodium triphosphate, phosphoric acid is reacted with sodium carbonate solution or sodium hydroxide solution in stoichiometric ratio and the solution is dewatered by spraying. In a similar way to Graham's salt and sodium diphosphate, pentasodium triphosphate dissolves numerous insoluble metal compounds (including lime soaps, etc.). Pentapotassium triphosphate, K₅P₃O₁₀ (potassium tripolyphosphate), is commercialized, for example, in the form of a 50% strength by weight solution (>23% P₂O₅, 25% K₂O). The potassium polyphosphates find broad application in the laundry detergents and cleaning products industry. There also exist sodium potassium tripolyphosphates, which may likewise be used for the purposes of the present invention. These are formed, for example, when sodium trimetaphosphate is hydrolyzed with KOH:

(NaPO₃)₃+2KOH→Na₃K₂P₃O₁₀+H₂O

They can be used in accordance with the invention in precisely the same way as sodium tripolyphosphate, potassium tripolyphosphate, or mixtures of these two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate, may also be used in accordance with the invention.

Processes which are preferred in the context of the present invention are those wherein the end products comprise phosphate(s), preferably alkali metal phosphate(s), with particular preference pentasodium or pentapotassium triphosphate (sodium or potassium tripolyphosphate), in amounts of from 20 to 80% by weight, preferably from 25 to 75% by weight, and in particular from 30 to 70% by weight, based in each case on the weight of the base tablet.

Further constituents present may be alkali metal carriers. Alkali metal carriers are, for example, alkali metal hydroxides, alkali metal carbonates, alkali metal hydrogen carbonates, alkali metal sesqui-carbonates, the abovementioned alkali metal silicates, alkali metal metasilicates, and mixtures of the abovementioned substances, preference being given in the context of this invention to the use of the alkali metal carbonates, especially sodium carbonate, sodium hydrogen carbonate, or sodium sesquicarbonate. Particular preference is given to a builder system comprising a mixture of tripolyphosphate and sodium carbonate. Likewise particularly preferred is a builder system comprising a mixture of tripolyphosphate and sodium carbonate and sodium disilicate.

In particularly preferred processes, the end product comprises carbonate(s) and/or hydrogen carbonate(s), preferably alkali metal carbonates, with particular preference sodium carbonate, in amounts of from 5 to 50% by weight, preferably from 7.5 to 40% by weight, and in particular from 10 to 30% by weight, based in each case on the weight of the end product.

Organic cobuilders which may be used in the laundry detergent and cleaning product tablets produced in accordance with the invention are, in particular, polycarboxylates/polycarboxylic acids, polymeric polycarboxylates, aspartic acid, polyacetals, dextrins, further organic cobuilders (see below), and phosphonates. These classes of substance are described below.

Organic builder substances which may be used are, for example, the polycarboxylic acids, usable in the form of their sodium salts, the term polycarboxylic acids meaning those carboxylic acids which carry more than one acid function. Examples of these are citric acid, adipic acid, succinic acid, glutaric acid, malic acid, tartaric acid, maleic acid, fumaric acid, sugar acids, amino carboxylic acids, nitrilotriacetic acid (NTA), provided such use is not objectionable on ecological grounds, and also mixtures thereof. Preferred salts are the salts of the polycarboxylic acids such as citric acid, adipic acid, succinic acid, glutaric acid, tartaric acid, sugar acids, and mixtures thereof.

The acids per se may also be used. In addition to their builder effect, the acids typically also possess the property of an acidifying component and thus also serve to establish a lower and milder pH of laundry detergents or cleaning products. In this context, mention may be made in particular of citric acid, succinic acid, glutaric acid, adipic acid, gluconic acid, and any desired mixtures thereof.

Also suitable as builders are polymeric polycarboxylates; these are, for example, the alkali metal salts of polyacrylic acid or of polymethacrylic acid, examples being those having a relative molecular mass of from 500 to 70,000 g/mol.

The molecular masses reported for polymeric polycarboxylates, for the purposes of this document, are weight-average molecular masses, M_{w}, of the respective acid form, determined basically by means of gel permeation chromatography (GPC) using a UV detector. The measurement was made against an external polyacrylic acid standard, which owing to its structural similarity to the polymers under investigation provides realistic molecular weight values. These figures differ markedly from the molecular weight values obtained using polystyrene-sulfonic acids as the standard. The molecular masses measured against polystyrenesulfonic acids are generally much higher than the molecular masses reported in this document.

Suitable polymers are, in particular, polyacrylates, which preferably have a molecular mass of from 2000 to 20,000 g/mol. owing to their superior solubility, preference in this group may be given in turn to the short-chain polyacrylates, which have molecular masses of from 2000 to 10,000 g/mol, and with particular preference from 3000 to 5000 g/mol.

Also suitable are copolymeric polycarboxylates, especially those of acrylic acid with methacrylic acid and of acrylic acid or methacrylic acid with maleic acid. Copolymers which have been found particularly suitable are those of acrylic acid with maleic acid which contain from 50 to 90% by weight acrylic acid and from 50 to 10% by weight maleic acid. Their relative molecular mass, based on free acids, is generally from 2000 to 70,000 g/mol, preferably from 20,000 to 50,000 g/mol, and in particular from 30,000 to 40,000 g/mol.

The (co)polymeric polycarboxylates can be used either as powders or as aqueous solutions. The (co)polymeric polycarboxylate content of the compositions is preferably from 0.5 to 20% by weight, in particular from 3 to 10% by weight.

In order to improve the solubility in water, the polymers may also contain allylsulfonic acids, such as allyloxybenzenesulfonic acid and methallylsulfonic acid, for example, as monomers.

Particular preference is also given to biodegradable polymers comprising more than two different monomer units, examples being those comprising, as monomers, salts of acrylic acid and of maleic acid, and also vinyl alcohol or vinyl alcohol derivatives, or those comprising, as monomers, salts of acrylic acid and of 2-alkylallylsulfonic acid, and also sugar derivatives.

Further preferred copolymers are those whose monomers are preferably acrolein and acrylic acid/acrylic acid salts, and, respectively, acrolein and vinyl acetate.

Similarly, further preferred builder substances that may be mentioned include polymeric amino dicarboxylic acids, their salts or their precursor substances. Particular preference is given to polyaspartic acids and their salts and derivatives, which have not only cobuilder properties but also a bleach-stabilizing action.

Further suitable builder substances are polyacetals, which may be obtained by reacting dialdehydes with polyol carboxylic acids having 5 to 7 carbon atoms and at least 3 hydroxyl groups. Preferred polyacetals are obtained from dialdehydes such as glyoxal, glutaraldehyde, terephthalaldehyde and mixtures thereof and from polyol carboxylic acids such as gluconic acid and/or glucoheptonic acid.

Further suitable organic builder substances are dextrins, examples being oligomers and polymers of carbohydrates, which may be obtained by partial hydrolysis of starches. The hydrolysis can be conducted by customary processes; for example, acid-catalyzed or enzyme-catalyzed processes. The hydrolysis products preferably have average molecular masses in the range from 400 to 500,000 g/mol. Preference is given here to a polysaccharide having a dextrose equivalent (DE) in the range from 0.5 to 40, in particular from 2 to 30, DE being a common measure of the reducing effect of a polysaccharide in comparison to dextrose, which possesses a DE of 100. It is possible to use both maltodextrins having a DE of between 3 and 20 and dry glucose syrups having a DE of between 20 and 37, and also so-called yellow dextrins and white dextrins having higher molecular masses, in the range from 2000 to 30,000 g/mol.

The oxidized derivatives of such dextrins comprise their products of reaction with oxidizing agents which are able to oxidize at least one alcohol function of the saccharide ring to the carboxylic acid function. Likewise suitable is an oxidized oligosaccharide in accordance with German Patent Application DE-A-196 00 018. A product oxidized at C₆ of the saccharide ring may be particularly advantageous.

Oxydisuccinates and other derivatives of disuccinates, preferably ethylenediamine disuccinate, are further suitable cobuilders. Ethylenediamine N,N′-disuccinate (EDDS) is used preferably in the form of its sodium or magnesium salts. Further preference in this context is given to glycerol disuccinates and glycerol trisuccinates as well. Suitable use amounts in formulations containing zeolite and/or silicate are from 3 to 15% by weight.

Examples of further useful organic cobuilders are acetylated hydroxy carboxylic acids and their salts, which may, if appropriate, also be present in lactone form and which contain at least 4 carbon atoms, at least one hydroxyl group, and not more than two acid groups.

A further class of substance having cobuilder properties is represented by the phosphonates. The phosphonates in question are, in particular, hydroxyalkane- and aminoalkanephosphonates. Among the hydroxyalkanephosphonates, 1-hydroxyethane-1,1-diphosphonate (HEDP) is of particular importance as a cobuilder. It is used preferably as the sodium salt, the disodium salt being neutral and the tetrasodium salt giving an alkaline (pH 9) reaction. Suitable aminoalkanephosphonates are preferably ethylenediamine-tetramethylenephosphonate (EDTMP), diethylenetriamine-pentamethylenephosphonate (DTPMP), and their higher homologs. They are used preferably in the form of the neutrally reacting sodium salts, e.g., as the hexasodium salt of EDTMP or as the hepta- and octa-sodium salt of DTPMP. As a builder in this case, preference is given to using HEDP from the class of the phosphonates. Furthermore, the aminoalkanephosphonates possess a pronounced heavy metal binding capacity. Accordingly, and especially if the compositions also contain bleach, it may be preferred to use aminoalkane-phosphonates, especially DTPMP, or to use mixtures of said phosphonates.

Furthermore, all compounds capable of forming complexes with alkaline earth metal ions may be used as cobuilders.

The amount of builder is usually between 10 and 70% by weight, preferably between 15 and 60% by weight, and in particular between 20 and 50% by weight. In turn, the amount of builders used is dependent on the intended use, so that bleach tablets may contain higher amounts of builders (for example, between 20 and 70% by weight, preferably between 25 and 65% by weight, and in particular between 30 and 55% by weight) than, say, laundry detergent tablets (usually from 10 to 50% by weight, preferably from 12.5 to 45% by weight, and in particular between 17.5 and 37.5% by weight).

In preferred processes, the laundry detergent and cleaning product tablets produced further comprise one or more surfactants. In this case it is possible to use anionic, nonionic, cationic and/or amphoteric surfactants, and/or mixtures thereof. From a performance standpoint, preference is given for laundry detergent tablets to mixtures of anionic and nonionic surfactants and for cleaning product tablets to nonionic surfactants. The total surfactant content of the laundry detergent tablets is—as already mentioned—from 5 to 60% by weight, based on the tablet weight, preference being given to surfactant contents of more than 15% by weight, while cleaning product tablets for machine dishwashing contain preferably less than 5% by weight of surfactant(s).

In the context of the present invention, preference is given, for producing laundry detergent tablets, to processes wherein anionic and nonionic surfactant(s) are used in the core tablet and/or in the particulate premix; performance advantages may result from certain proportions in which the individual classes of surfactant are used.

For example, particular preference is given to processes wherein the ratio of anionic surfactant(s) to nonionic surfactant(s) in the end products is between 10:1 and 1:10, preferably between 7.5:1 and 1:5, and in particular between 5:1 and 1:2. Also preferred are processes wherein the laundry detergent and cleaning product tablets comprise surfactant(s), preferably anionic and/or nonionic surfactant(s), in amounts of from 5 to 40% by weight, preferably from 7.5 to 35% by weight, with particular preference from 10 to 30% by weight, and in particular from 12.5 to 25% by weight, based in each case on the tablet weight.

From a performance standpoint it may be advantageous if certain classes of surfactant are absent from some phases of the laundry detergent and cleaning product tablets or from the tablet as a whole, i.e., from all phases. A further important embodiment of the present invention therefore envisages that at least one phase of the tablets is free from nonionic surfactants.

Conversely, however, the presence of certain surfactants in individual phases or in the whole tablet, i.e., in all phases, may also produce a positive effect. The incorporation of the above-described alkyl polyglycosides has been found advantageous, and so preference is given to laundry detergent and cleaning product tablets in which at least one phase of the tablets comprises alkyl polyglycosides.

Similarly to the case with the nonionic surfactants, the omission of anionic surfactants from certain phases or all phases may also result in laundry detergent and cleaning product tablets better suited to certain fields of application. In the context of the present invention, therefore, it is also possible to produce laundry detergent and cleaning product tablets in which at least one phase of the tablets is free from anionic surfactants.

As already mentioned, the use of surfactants in the case of cleaning product tablets for machine dishwashing is preferably limited to the use of nonionic surfactants in small amounts. Laundry detergent and cleaning product tablets producible preferably for use as cleaning product tablets in the context of the present invention are those wherein the sum of all particulate premixes used has total surfactant contents of less than 5% by weight, preferably less than 4% by weight, with particular preference less than 3% by weight, and in particular less than 2% by weight, based in each case on the weight of all premixes. Surfactants used in machine dishwashing compositions are usually only low-foaming nonionic surfactants. Representatives from the groups of the anionic, cationic and amphoteric surfactants, in contrast, are of relatively little importance. With particular preference, the cleaning product tablets of the invention for machine dishwashing comprise nonionic surfactants, especially nonionic surfactants from the group of the alkoxylated alcohols. Preferred nonionic surfactants used are alkoxylated, advantageously ethoxylated, especially primary alcohols having preferably 8 to 18 carbon atoms and on average from 1 to 12 mol of ethylene oxide (EO) per mole of alcohol, in which the alcohol radical may be linear or, preferably, methyl-branched in position 2 and/or may contain a mixture of linear and methyl-branched radicals, as are customarily present in oxo alcohol radicals. Particular preference is given, however, to alcohol ethoxylates having linear radicals from alcohols of natural origin having 12 to 18 carbon atoms, e.g., from coconut, palm, tallow fatty or oleyl alcohol, and having on average from 2 to 8 EO per mole of alcohol. The preferred ethoxylated alcohols include, for example, C₁₂₋₁₄ alcohols having 3 EO or 4 EO, C₉₋₁₁ alcohol having 7 EO, C₁₃₋₁₅ alcohols having 3 EO, 5 EO, 7 EO or 8 EO, C₁₂₋₁₈ alcohols having 3 EO, 5 EO or 7 EO, and mixtures of these, such as mixtures of C₁₂₋₁₄ alcohol having 3 EO and C₁₂₋₁₈ alcohol having 5 EO. The stated degrees of ethoxylation are statistical means, which for a specific product may be an integer or a fraction. Preferred alcohol ethoxylates have a narrowed homolog distribution (narrow range ethoxylates, NREs). In addition to these nonionic surfactants, fatty alcohols having more than 12 EO may also be used. Examples thereof are tallow fatty alcohol having 14 EO, 25 EO, 30 EO, or 40 EO.

In order to facilitate the disintegration of highly compacted tablets, it is possible to incorporate disintegration aids, known as tablet disintegrants, in the process of the invention in order to reduce the disintegration times. Tablet disintegrants, or disintegration accelerators, are understood in accordance with Römpp (9th Edition, Vol. 6, p. 4440) and Voigt “Lehrbuch der pharmazeutischen Technologie” [Textbook of pharmaceutical technology] (6th Edition, 1987, pp. 182-184) to be auxiliaries which ensure the rapid disintegration of tablets in water or gastric fluid and the release of the drugs in absorbable form.

These substances increase in volume on ingress of water, with on the one hand an increase in the intrinsic volume (swelling) and on the other hand, by way of the release of gases, the possible generation of a pressure which causes the tablets to disintegrate into smaller particles. Examples of established disintegration aids are carbonate/citric acid systems, with the use of other organic acids also being possible. Examples of swelling disintegration aids are synthetic polymers such as polyvinylpyrrolidone (PVP) or natural polymers and/or modified natural substances such as cellulose and starch and their derivatives, alginates, or casein derivatives.

Preferred laundry detergent and cleaning product tablets contain from 0.5 to 10% by weight, preferably from 3 to 7% by weight, and in particular from 4 to 6% by weight, of one or more disintegration aids, based in each case on the tablet weight. If only the base tablet comprises disintegration aids, then these figures are based only on the weight of the base tablet.

Preferred disintegrants used in the context of the present invention are cellulose-based disintegrants and so preferred laundry detergent and cleaning product tablets comprise a cellulose-based disintegrant of this kind in amounts from 0.5 to 10% by weight, preferably from 3 to 7% by weight, and in particular from 4 to 6% by weight. Pure cellulose has the formal empirical composition (C₆H₁CO₅)ₙ and, considered formally, is a β-1,4-polyacetal of cellobiose, which itself is constructed of two molecules of glucose. Suitable celluloses consist of from about 500 to 5000 glucose units and, accordingly, have average molecular masses of from 50,000 to 500,000. Cellulose-based disintegrants which can be used also include, in the context of the present invention, cellulose derivatives obtainable by polymer-analogous reactions from cellulose. Such chemically modified celluloses include, for example, products of esterifications and etherifications in which hydroxy hydrogen atoms have been substituted. However, celluloses in which the hydroxy groups have been replaced by functional groups not attached by an oxygen atom may also be used as cellulose derivatives. The group of the cellulose derivatives embraces, for example, alkali metal celluloses, carboxymethylcellulose (CMC), cellulose esters and cellulose ethers and aminocelluloses. Said cellulose derivatives are preferably not used alone as cellulose-based disintegrants but instead are used in a mixture with cellulose. The cellulose derivative content of these mixtures is preferably less than 50% by weight, with particular preference less than 20% by weight, based on the cellulose-based disintegrant. The particularly preferred cellulose-based disintegrant used is pure cellulose, free from cellulose derivatives.

The cellulose used as disintegration aid is preferably not used in finely divided form but instead is converted into a coarser form, for example, by granulation or compaction, before being admixed to the premixes intended for compression. Laundry detergent and cleaning product tablets comprising disintegrants in granular or optionally cogranulated form are described in German Patent Applications DE 197 09 991 (Stefan Herzog) and DE 197 10 254 (Henkel) and in International Patent Application W098/40463 (Henkel). These documents also provide further details on the production of granulated, compacted or cogranulated cellulose disintegrants. The particle sizes of such disintegrants are usually above 200 μm, preferably between 300 and 1600 μm to the extent of at least 90%, and in particular between 400 and 1200 μm to the extent of at least 90%. The abovementioned, relatively coarse cellulose-based disintegration aids, and those described in more detail in the cited documents, are preferred for use as disintegration aids in the context of the present invention and are available commercially, for example, under the designation Arbocel® TF-30-HG from the company Rettenmaier.

As a further cellulose-based disintegrant or as a constituent of this component it is possible to use microcrystalline cellulose. This microcrystalline cellulose is obtained by partial hydrolysis of celluloses under conditions which attack only the amorphous regions (approximately 30% of the overall cellulose mass) of the celluloses and break them up completely but leave the crystalline regions (approximately 70%) intact. Subsequent deaggregation of the microfine celluloses resulting from the hydrolysis yields the microcrystalline celluloses, which have primary particle sizes of approximately 5 μm and can be compacted, for example, to granules having an average particle size of 200 μm.

Processes which are preferred in the context of the present invention are those wherein the laundry detergent and cleaning product tablets produced using them further comprise a disintegration aid, preferably a cellulose-based disintegration aid, preferably in granular, cogranulated or compacted form, in amounts of from 0.5 to 10% by weight, preferably from 3 to 7% by weight, and in particular from 4 to 6% by weight, based in each case on the tablet weight.

The laundry detergent and cleaning product tablets produced in accordance with the invention may further comprise, both in the base tablet and in the core tablet, a gas-evolving effervescent system. Said gas-evolving effervescent system may consist of a single substance which on contact with water releases a gas. Among these compounds mention may be made, in particular, of magnesium peroxide, which on contact with water releases oxygen. Normally, however, the gas-releasing effervescent system consists in its turn of at least two constituents which react with one another and, in so doing, form gas. Although a multitude of systems which release, for example, nitrogen, oxygen or hydrogen are conceivable and feasible here, the effervescent system used in the laundry detergent and cleaning product tablets of the invention will be selectable on the basis of both economic and environmental considerations. Preferred effervescent systems consist of alkali metal carbonate and/or alkali metal hydrogen carbonate and of an acidifier apt to release carbon dioxide from the alkali metal salts in aqueous solution.

Among the alkali metal carbonates and/or alkali metal hydrogen carbonates, the sodium and potassium salts are much preferred over the other salts on grounds of cost. It is of course not mandatory to use the single alkali metal carbonates or alkali metal hydrogen carbonates in question; rather, mixtures of different carbonates and hydrogen carbonates may be preferred from the standpoint of wash technology.

In preferred laundry detergent and cleaning product tablets, the effervescent system used comprises from 2 to 20% by weight, preferably from 3 to 15% by weight, and in particular from 5 to 10% by weight, of an alkali metal carbonate or alkali metal hydrogen carbonate, and from 1 to 15, preferably from 2 to 12, and in particular from 3 to 10, % by weight of an acidifier, based in each case on the overall tablet.

As examples of acidifiers which release carbon dioxide from the alkali metal salts in aqueous solution it is possible to use boric acid and also alkali metal hydrogen sulfates, alkali metal hydrogen phosphates, and other inorganic salts. Preference is given, however, to the use of organic acidifiers, with citric acid being a particularly preferred acidifier. However, it is also possible, in particular, to use the other solid mono-, oligo- and polycarboxylic acids. Preferred among this group, in turn, are tartaric acid, succinic acid, malonic acid, adipic acid, maleic acid, fumaric acid, oxalic acid, and polyacrylic acid. Organic sulfonic acids such as amidosulfonic acid may likewise be used. A commercially available acidifier which is likewise preferred for use in the context of the present invention is Sokalan® DCS (trademark of BASF), a mixture of succinic acid (max. 31% by weight), glutaric acid (max. 50% by weight), and adipic acid (max. 33% by weight).

In the context of the present invention, preference is given as process end products to laundry detergent and cleaning product tablets where the acidifier used in the effervescent system comprises a substance from the group of the organic di-, tri- and oligocarboxylic acids, or mixtures thereof.

In addition to the abovementioned constituents, builder, surfactant and disintegration aid, the laundry detergent and cleaning product tablets produced in accordance with the invention may comprise further customary laundry detergent and cleaning product ingredients from the group consisting of bleaches, bleach activators, dyes, fragrances, optical brighteners, enzymes, foam inhibitors, silicone oils, antiredeposition agents, graying inhibitors, color transfer inhibitors, and corrosion inhibitors.

Among the compounds used as bleaches which yield H₂O₂ in water, particular importance is possessed by sodium percarbonate. Further bleaches which may be used are, for example, sodium perborate tetrahydrate and sodium perborate monohydrate, peroxypyrophosphates, citrate perhydrates, and H₂O₂-donating peracidic salts or peracids, such as perbenzoates, peroxophthalates, diperazelaic acid, phthaloiminoper acid or diper-dodecanedioic acid. Cleaning products of the invention may also comprise bleaches from the group of organic bleaches. Typical organic bleaches are the diacyl peroxides, such as dibenzoyl peroxide, for example. Further typical organic bleaches are the peroxy acids, particular examples being the alkyl peroxy acids and the aryl peroxy acids. Preferred representatives are (a) peroxybenzoic acid and its ring-substituted derivatives, such as alkylperoxybenzoic acids, and also peroxy-α-naphthoic acid and magnesium monoperphthalate, (b) aliphatic or substituted aliphatic peroxy acids, such as peroxylauric acid, peroxystearic acid, ε-phthalimidoperoxycaproic acid [phthaloiminoperoxy-hexanoic acid (PAP)], o-carboxybenzamidoperoxycaproic acid, N-nonenylamidoperadipic acid and N-nonenylamidopersuccinates, and (c) aliphatic and araliphatic peroxy dicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid and N,N-terephthaloyldi(6-aminopercaproic acid) may be used.

Bleaches used in the cleaning product tablets produced in accordance with the invention for machine dishwashing may also be substances which release chlorine or bromine. Among suitable chlorine- or bromine-releasing materials, examples include heterocyclic N-bromoamides and N-chloroamides, examples being trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable.

The bleaches are used in machine dishwashing compositions usually in amounts of from 1 to 30% by weight, preferably from 2.5 to 20% by weight, and in particular from 5 to 15% by weight, based in each case on the composition. In the context of the present invention, these proportions relate to the weight of the base tablet.

Bleach activators, which boost the action of the bleaches, may likewise be a constituent of the base tablet. Known bleach activators are compounds containing one or more N-acyl and/or O-acyl groups, such as substances from the class of the anhydrides, esters, imides and acylated imidazoles or oximes. Examples are tetraacetylethylenediamine TAED, tetraacetylmethylenediamine TAMD, and tetraacetylhexylenediamine TAHD, and also pentaacetylglucose PAG, 1,5-diacetyl-2,2-dioxohexahydro-1,3,5-triazine DADHT, and isatoic anhydride ISA.

Bleach activators which may be used are compounds which under perhydrolysis conditions give rise to aliphatic peroxo carboxylic acids having preferably 1 to 10 carbon atoms, in particular 2 to 4 carbon atoms, and/or substituted or unsubstituted perbenzoic acid. Suitable substances are those which carry 0-acyl and/or N-acyl groups of the stated number of carbon atoms, and/or substituted or unsubstituted benzoyl groups. Preference is given to polyacylated alkylenediamines, especially tetraacetylethylenediamine (TAED), acylated triazine derivatives, especially 1,5-diacetyl-2,4-dioxohexahydro-1,3,5-triazine (DADHT), acylated glycolurils, especially tetraacetylglycoluril (TAGU), N-acyl imides, especially N-nonanoylsuccinimide (NOSI), acylated phenolsulfonates, especially n-nonanoyl- or isononanoyloxybenzenesulfonate (n- or iso-NOBS), carboxylic anhydrides, especially phthalic anhydride, acylated polyhydric alcohols, especially triacetin, ethylene glycol diacetate, 2,5-diacetoxy-2,5-dihydrofuran, N-methylmorpholiniumacetonitrile methyl sulfate (MMA), and the enol esters known from German Patent Applications DE 196 16 693 and DE 196 16 767, and also acetylated sorbitol and mannitol and/or mixtures thereof (SORMAN), acylated sugar derivatives, especially pentaacetylglucose (PAG), pentaacetylfructose, tetraacetylxylose and octaacetyllactose, and acetylated, optionally N-alkylated glucamine and gluconolactone, and/or N-acylated lactams, for example, N-benzoylcaprolactam. Hydrophilically substituted acylacetals and acyllactams are likewise used with preference. Combinations of conventional bleach activators may also be used. The bleach activators are used in machine dishwashing compositions usually in amounts of from 0.1 to 20% by weight, preferably from 0.25 to 15% by weight, and in particular from 1 to 10% by weight, based in each case on the composition. In the context of the present invention, the stated proportions relate to the weight of the base tablet.

In addition to the conventional bleach activators, or instead of them, it is also possible to use what are known as bleaching catalysts in the process of the invention. These substances are bleach-boosting transition metal salts or transition metal complexes such as, for example, Mn-, Fe-, Co-, Ru- or Mo-salen complexes or -carbonyl complexes. Other bleaching catalysts which can be used include Mn, Fe, Co, Ru, Mo, Ti, V and Cu complexes with N-containing tripod ligands, and also Co-, Fe-, Cu- and Ru-ammine complexes.

Preference is given to the use of bleach activators from the group of polyacylated alkylenediamines, especially tetraacetylethylenediamine (TAED), N-acyl imides, especially N-nonanoylsuccinimide (NOSI), acylated phenolsulfonates, especially n-nonanoyl- or isononanoyloxybenzenesulfonate (n- or iso-NOBS), N-methylmorpholiniumacetonitrile methyl sulfate (MMA), preferably in amounts of up to 10% by weight, in particular from 0.1% by weight to 8% by weight, more particularly from 2 to 8% by weight, and with particular preference from 2 to 6% by weight, based on the overall composition.

Bleach-boosting transition metal complexes, especially those with the central atoms Mn, Fe, Co, Cu, Mo, V, Ti and/or Ru, preferably selected from the group of manganese and/or cobalt salts and/or complexes, with particular preference from cobalt ammine complexes, cobalt acetato complexes, cobalt carbonyl complexes, the chlorides of cobalt or manganese, and manganese sulfate, are used in customary amounts, preferably in an amount of up to 5% by weight, in particular from 0.0025% by weight to 1% by weight, and with particular preference from 0.01% by weight to 0.25% by weight, based in each case on the overall composition. In specific cases, however, it is also possible to use a greater amount of bleach activator.

Processes in step c) of which use is made of bleaches from the group consisting of oxygen or halogen bleaches, especially chlorine bleaches, with particular preference sodium perborate and sodium percarbonate, in amounts of from 2 to 25% by weight, preferably from 5 to 20% by weight, and in particular from 10 to 15% by weight, based in each case on the weight of the premix, are an inventively preferred embodiment of the present invention.

It is likewise preferred for the base tablet and/or the core tablet to comprise bleach activators. Processes wherein the premix in step c) comprises bleach activators from the groups of polyacylated alkylenediamines, especially tetraacetylethylenediamine (TAED), N-acyl imides, especially N-nonanoylsuccinimide (NOSI), acylated phenolsulfonates, especially n-nonanoyl- or isononanoyloxybenzenesulfonate (n- or iso-NOBS), and N-methylmorpholiniumacetonitrile methyl sulfate (MMA), in amounts of from 0.25 to 15% by weight, preferably from 0.5 to 10% by weight, and in particular from 1 to 5% by weight, based in each case on the weight of the base tablet, are likewise preferred.

The cleaning product tablets produced in accordance with the invention may include, especially in the base tablet, corrosion inhibitors for protecting the ware or the machine, with special importance in the field of machine dishwashing being possessed, in particular, by silver protectants. The known substances of the prior art may be used. In general it is possible to use, in particular, silver protectants selected from the group consisting of triazoles, benzotriazoles, bisbenzotriazoles, aminotriazoles, alkylaminotriazoles, and transition metal salts or transition metal complexes. Particular preference is given to the use of benzotriazole and/or alkylaminotriazole. Frequently encountered in cleaning formulations, furthermore, are agents containing active chlorine, which may significantly reduce corrosion of the silver surface. In chlorine-free cleaners, use is made in particular of oxygen-containing and nitrogen-containing organic redox-active compounds, such as divalent and trivalent phenols, e.g. hydroquinone, pyrocatechol, hydroxy-hydroquinone, gallic acid, phloroglucinol, pyrogallol, and derivatives of these classes of compound. Inorganic compounds in the form of salts and complexes, such as salts of the metals Mn, Ti, Zr, Hf, V, Co and Ce, also find frequent application. Preference is given in this context to the transition metal salts selected from the group consisting of manganese and/or cobalt salts and/or complexes, with particular preference cobalt ammine complexes, cobalt acetato complexes, cobalt carbonyl complexes, the chlorides of cobalt or of manganese and manganese sulfate. Similarly, zinc compounds may be used to prevent corrosion on the ware.

In processes which are preferred in the context of the present invention, silver protectants from the group consisting of triazoles, benzotriazoles, bisbenzotriazoles, aminotriazoles, alkylaminotriazoles and the transition metal salts or transition metal complexes, with particular preference benzotriazole and/or alkylaminotriazole, in amounts of from 0.01 to 5% by weight, preferably from 0.05 to 4% by weight, and in particular from 0.5 to 3% by weight, based in each case on the weight of the process end product, are used.

Additionally, of course, the core tablet may comprise silver protectants, in which case the base tablet either likewise comprises silver protectants or is free of such compounds.

In addition to the abovementioned ingredients, further classes of substance are suitable for incorporation into laundry detergents and cleaning products. Thus, preferred processes are those in step c) of which use is further made of one or more substances from the groups consisting of enzymes, corrosion inhibitors, scale inhibitors, cobuilders, dyes and/or fragrances in total amounts of from 6 to 30% by weight, preferably from 7.5 to 25% by weight, and in particular from 10 to 20% by weight, based in each case on the weight of the process end product.

Suitable enzymes include in particular those from the classes of the hydrolases such as the proteases, esterases, lipases or lipolytic enzymes, amylases, glycosyl hydrolases, and mixtures of said enzymes. All of these hydrolases contribute to removing stains, such as proteinaceous, fatty or starchy marks. For bleaching, it is also possible to use oxidoreductases. Especially suitable enzymatic active substances are those obtained from bacterial strains or fungi such as Bacillus subtilis, Bacillus licheniformis, Streptomyceus griseus, Coprinus cinereus and Humicola insolens, and also from genetically modified variants thereof. Preference is given to the use of proteases of the subtilisin type, and especially to proteases obtained from Bacillus lentus. Of particular interest in this context are enzyme mixtures, examples being those of protease and amylase or protease and lipase or lipolytic enzymes, or of protease, amylase and lipase or lipolytic enzymes, or protease, lipase or lipolytic enzymes, but especially protease and/or lipase-containing mixtures or mixtures with lipolytic enzymes. Examples of such lipolytic enzymes are the known cutinases. Peroxidases or oxidases have also proven suitable in some cases. The suitable amylases include, in particular, alpha-amylases, iso-amylases, pullulanases, and pectinases.

The enzymes may be adsorbed on carrier substances or embedded in coating substances in order to protect them against premature decomposition. The proportion of the enzymes, enzyme mixtures or enzyme granules may be, for example, from about 0.1 to 5% by weight, preferably from 0.5 to about 4.5% by weight. In cleaning product tablets which are preferred in the context of the present invention, the base tablet comprises protease and/or amylase.

Dyes and fragrances may be added to the laundry detergent or cleaning product tablets produced in accordance with the invention, both in the base tablet and in the core tablet, in order to enhance the esthetic appeal of the products which are formed and to provide the consumer with not only the performance but also a visually and sensorially “typical and unmistakable” product. As perfume oils and/or fragrances it is possible to use individual odorant compounds, examples being the synthetic products of the ester, ether, aldehyde, ketone, alcohol, and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate, and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial and bourgeonal; the ketones include, for example, the ionones, α-isomethylionone and methyl cedryl ketone; the alcohols include anethole, citronellol, eugenol, geraniol, linalool, phenylethyl alcohol, and terpineol; the hydrocarbons include primarily the terpenes such as limonenes and pinene. Preference, however, is given to the use of mixtures of different odorants, which together produce an appealing fragrance note. Such perfume oils may also contain natural odorant mixtures, as obtainable from plant sources, examples being pine oil, citrus oil, jasmine oil, patchouli oil, rose oil or ylang-ylang oil. Likewise suitable are clary sage oil, camomile oil, clove oil, balm oil, mint oil, cinnamon leaf oil, lime blossom oil, juniperberry oil, vetiver oil, olibanum oil, galbanum oil and labdanum oil, and also orange blossom oil, neroli oil, orange peel oil, and sandalwood oil.

The fragrances may be incorporated directly into the laundry detergent and cleaning products produced in accordance with the invention; alternatively, it may be advantageous to apply the fragrances to carriers which intensify the adhesion of the perfume on the laundry and, by means of slower fragrance release, ensure long-lasting fragrance of the textiles. Materials which have become established as such carriers are, for example, cyclodextrins, it being possible in addition for the cyclodextrin-perfume complexes to be additionally coated with further auxiliaries.

In order to enhance the esthetic appeal of the laundry detergent and cleaning product tablets produced in accordance with the invention, they (or parts thereof) may be colored with appropriate dyes. Preferred dyes, whose selection presents no difficulty whatsoever to the skilled worker, possess a high level of storage stability and insensitivity to the other ingredients of the compositions or to light and possess no pronounced affinity for the substrates to be treated with the compositions, such as textiles, glass, ceramic, or plastic tableware, so as not to stain them.

The tablets in the process of the invention are produced in step f) by compression to tablets, in which context it is possible to have recourse to conventional processes. To produce the tablets, the premix, comprising at least one core tablet, is compacted in a so-called die between two punches to form a solid compact. This operation, which is referred to below for short as tableting, is divided into four sections: metering, compaction (elastic deformation), plastic deformation, and ejection.

First of all, the premix and the core tablet(s) are introduced into the die, the fill level and thus the weight and form of the resulting tablet being determined by the position of the lower punch and by the form of the compression tool. Even in the case of high tablet throughputs, constant premix metering is preferably achieved by volumetric metering of the premix. In the subsequent course of tableting, the upper punch contacts the premix and is lowered further in the direction of the lower punch. In the course of this compaction the particles of the premix are pressed closer to one another, with a continual reduction in the void volume within the filling between the punches. When the upper punch reaches a certain position (and thus when a certain pressure is acting on the premix), plastic deformation begins, in which the particles coalesce and the tablet is formed. Depending on the physical properties of the premix, a portion of the premix particles is also crushed and at even higher pressures there is sintering of the premix. With an increasing compression rate, i.e., high throughputs, the phase of elastic deformation becomes shorter and shorter, with the result that the tablets formed may have larger or smaller voids. In the final step of tableting, the finished tablet is ejected from the die by the lower punch and conveyed away by means of downstream transport means. At this point in time, it is only the weight of the tablet which has been ultimately defined, since the compacts may still change their form and size as a result of physical processes (elastic relaxation, crystallographic effects, cooling, etc).

Tableting takes place in commercially customary tableting presses, which may in principle be equipped with single or double punches. In the latter case, pressure is built up not only using the upper punch; the lower punch as well moves toward the upper punch during the compression operation, while the upper punch presses downward. For small production volumes it is preferred to use eccentric tableting presses, in which the punch or punches is or are attached to an eccentric disk, which in turn is mounted on an axle having a defined speed of rotation. The movement of these compression punches is comparable with the way in which a customary four-stroke engine works. Compression can take place with one upper and one lower punch, or else a plurality of punches may be attached to one eccentric disk, the number of die bores being increased correspondingly. The throughputs of eccentric presses vary, depending on model, from several hundred up to a maximum of 3000 tablets per hour.

For greater throughputs, the apparatus chosen comprises rotary tableting presses, in which a relatively large number of dies is arranged in a circle on a so-called die table. Depending on model, the number of dies varies between 6 and 55, larger dies also being obtainable commercially. Each die on the die table is allocated an upper punch and a lower punch, it being possible again for the compressive pressure to be built up actively by the upper punch or lower punch only or else by both punches. The die table and the punches move around a common, vertical axis, and during rotation the punches, by means of raillike cam tracks, are brought into the positions for filling, compaction, plastic deformation, and ejection. At those sites where very considerable raising or lowering of the punches is necessary (filling, compaction, ejection), these cam tracks are assisted by additional low-pressure sections, low-tension rails, and discharge tracks. The die is filled by way of a rigid supply means, known as the filling shoe, which is connected to a stock vessel for the premix. The compressive pressure on the premix can be adjusted individually for upper punch and lower punch by way of the compression paths, the buildup of pressure taking place by the rolling movement of the punch shaft heads past displaceable pressure rolls.

In order to increase the throughput, rotary presses may also be provided with two filling shoes, in which case only one half-circle need be traveled to produce one tablet. For the production of two-layer and multilayer tablets, a plurality of filling shoes are arranged in series, and the gently pressed first layer is not ejected before further filling. By means of an appropriate process regime it is possible in this way to produce laminated tablets and inlay tablets as well, having a construction like that of an onion skin, where in the case of the inlay tablets the top face of the core or of the core layers is not covered and therefore remains visible. Rotary tableting presses can also be equipped with single or multiple tools, so that, for example, an outer circle with 50 bores and an inner circle with 35 bores are used simultaneously for compression. The throughputs of modern rotary tableting presses amount to more than a million tablets per hour.

When tableting with rotary presses it has been found advantageous to perform tableting with minimal fluctuations in tablet weight. Fluctuations in tablet hardness can also be reduced in this way. Small fluctuations in weight can be achieved as follows:

use of plastic inserts with small thickness tolerances

low rotor speed

large filling shoes

harmonization between the filling shoe wing rotary speed and the speed of the rotor

filling shoe with constant powder height

decoupling of filling shoe and powder charge

To reduce caking on the punches, all of the anti-adhesion coatings known from the art are available. Polymer coatings, plastic inserts or plastic punches are particularly advantageous. Rotating punches have also been found advantageous, in which case, where possible, upper punch and lower punch should be of rotatable configuration. In the case of rotating punches, it is generally possible to do without a plastic insert. In this case the punch surfaces should be electropolished.

It has also been found that long compression times are advantageous. These times can be established using pressure rails, a plurality of pressure rolls, or low rotor speeds. Since the fluctuations in tablet hardness are caused by the fluctuations in the compressive forces, systems should be employed which limit the compressive force. In this case it is possible to use elastic punches, pneumatic compensators, or sprung elements in the force path. In addition, the pressure roll may be of sprung design.

Tableting machines suitable in the context of the present invention are obtainable, for example, from the following companies: Apparatebau Holzwarth GbR, Asperg, Wilhelm Fette GmbH, Schwarzenbek, Hofer GmbH, Weil, Horn & Noack Pharmatechnik GmbH, Worms, IMA Verpackungssysteme GmbH, Viersen, KILIAN, Cologne, KOMAGE, Kell am See, KORSCH Pressen AG, Berlin, and Romaco GmbH, Worms. Examples of further suppliers are Dr. Herbert Pete, Vienna (AU), Mapag Maschinenbau AG, Berne (CH), BWI Manesty, Liverpool (GB), I. Holland Ltd., Nottingham (GB), Courtoy N.V., Halle (BE/LU), and Medicopharm, Kamnik (SI). A particularly suitable apparatus is, for example, the hydraulic double-pressure press HPF 630 from LAEIS, D. Tableting tools are obtainable, for example, from the following companies: Adams Tablettierwerkzeuge, Dresden, Wilhelm Fett GmbH, Schwarzenbek, Klaus Hammer, Solingen, Herber & Sohne GmbH, Hamburg, Hofer GmbH, Weil, Horn & Noack Pharmatechnik GmbH, Worms, Ritter Pharmatechnik GmbH, Hamburg, Romaco GmbH, Worms, and Notter Werkzeugbau, Tamm. Further suppliers are, for example, Senss AG, Reinach (CH) and Medicopharm, Kamnik (SI).

The tablets can be produced—as already mentioned earlier above—in predetermined three-dimensional forms and predetermined sizes. Suitable three-dimensional forms are virtually any practicable designs—i.e., for example, bar, rod or ingot form, cubes, blocks and corresponding three-dimensional elements having planar side faces, and in particular cylindrical designs with a circular or oval cross section. This latter design covers forms ranging from tablets through to compact cylinders having a height-to-diameter ratio of more than 1.

After compression, the laundry detergent and cleaning product tablets possess high stability. The fracture strength of cylindrical tablets can be gaged by way of the parameter of diametral fracture stress. This diametral fracture stress can be determined by

$$σ = \frac{2 P}{π Dt}$$

where σ represents the diametral fracture stress (DFS) in Pa, P is the force in N which leads to the pressure exerted on the tablet, which pressure causes the fracture of the tablet, D is the tablet diameter in meters, and t is the tablet height.

The tablets produced in accordance with the invention may be provided in whole or in part with a coating. Processes wherein an optional aftertreatment comprises applying a coating layer to the tablet area(s) in which the core tablets are located, or applying a coating layer to the entire tablet, are preferred in accordance with the invention.

Following production, the laundry detergent and cleaning product tablets produced in accordance with the invention may be packaged, the use of certain packaging systems having proven particularly useful since these packaging systems increase the storage stability of the ingredients. The present invention therefore additionally provides a combination of (a) laundry detergent and cleaning product tablet(s) produced in accordance with the invention and a packaging system containing the laundry detergent and cleaning product tablet(s), said packaging system having a moisture vapor transmission rate of from 0.1 g/m²/day to less than 20 g/m²/day if said packaging system is stored at 23° C. and a relative equilibrium humidity of 85%.

The packaging system of the combination of laundry detergent and cleaning product tablet(s) and packaging system has a moisture vapor transmission rate of from 0.1 g/m²/day to less than 20 g/m²/day when said packaging system is stored at 23° C. and a relative equilibrium humidity of 85%. These temperature and humidity conditions are the test conditions specified in DIN Standard 53122, which allows minimal deviations (23±1° C., 85±2% relative humidity). The moisture vapor transmission rate of a given packaging system or material may be determined in accordance with further standard methods and is also described, for example, in ASTM Standard E-96-53T (“Test for measuring water vapor transmission of materials in sheet form”) and in TAPPI Standard T464 m-45 (“Water vapor permeability of sheet materials at high temperature and humidity”). The measurement principle of common techniques is based on the water uptake of anhydrous calcium chloride which is stored in a container in the appropriate atmosphere, the container being closed at the top face with the material to be tested. From the surface area of the container closed with the material to be tested (permeation area), the weight gain of the calcium chloride, and the exposure time, the moisture vapor transmission rate may be calculated as follows:

$$MVTR = \frac{20 \cdot 10 \text{,} 000}{A} \cdot \frac{x}{y} [ g / {m}^{2} / 24 h ]$$

where A is the area of the material to be tested in cm², x is the weight gain of the calcium chloride in g, and y is the exposure time in h.

The relative equilibrium humidity, often referred to as “relative atmospheric humidity”, is 85% at 23° C. when the moisture vapor transmission rate is measured in the context of the present invention. The ability of air to accommodate water vapor increases with temperature up to a particular maximum content, the so-called saturation content, and is specified in g/m³. For example, 1 m³ of air at 17° is saturated with 14.4 g of water vapor; at a temperature of 11°, saturation is reached with just 10 g of water vapor. The relative atmospheric humidity is the ratio, expressed as a percentage, of the actual water vapor content to the saturation content at the prevailing temperature. If, for example, air at 17° contains 12 g/m³ water vapor, then the relative atmospheric humidity=(12/14.4)·100=83%. If this air is cooled, then saturation (100% RH) is reached at what is known as the dew point (in the example: 14°), i.e., on further cooling a precipitate is formed in the form of mist (dew). The humidity is determined quantitatively using hygrometers and psychrometers.

The relative equilibrium humidity of 85% at 23° C. can be established precisely, for example, in laboratory chambers with humidity control, to +/−2% RH depending on the type of apparatus. In addition, constant and well-defined relative atmospheric humidities are formed in closed systems at a given temperature over saturated solutions of certain salts, these humidities deriving from the phase equilibrium between water partial pressure, saturated solution, and sediment.

The combinations of the invention, comprising laundry detergent and cleaning product tablets and packaging system, may of course in turn be packaged in secondary packaging, examples being cartons or trays, there being no need to impose further requirements on the secondary packaging. The secondary packaging, accordingly, is possible but not necessary.

Packaging systems which are preferred in the context of the present invention have a moisture vapor transmission rate of from 0.5 g/m²/day to less than 15 g/m²/day.

Depending on the embodiment of the invention, the packaging system of the combination of the invention contains one or more laundry detergent and cleaning product tablets. In accordance with the invention it is preferred either to design a tablet such that it comprises one application unit of the laundry detergent and cleaning product, and to package this tablet individually, or to pack into one packaging unit the number of tablets which totals one application unit. In the case of an intended dose of 80 g of laundry detergent and cleaning product, therefore, it is possible in accordance with the invention to produce and package individually one laundry detergent and cleaning product tablet weighing 80 g, but in accordance with the invention it is also possible to pack two laundry detergent and cleaning product tablets each weighing 40 g into one pack in order to arrive at a combination in accordance with the invention. This principle can of course be extended, so that, in accordance with the invention, combinations may also comprise three, four, five or even more laundry detergent and cleaning product tablets in one packaging unit. Of course, two or more tablets in a pack may have different compositions. In this way it is possible to separate certain components spatially from one another in order, for example, to avoid stability problems.

The packaging system of the combination of the invention may consist of a very wide variety of materials and may adopt any desired external forms. For reasons of economy and of greater ease of processing, however, preference is given to packaging systems in which the packaging material has a low weight, is easy to process, and is inexpensive. In combinations which are preferred in accordance with the invention, the packaging system consists of a bag or pouch of single-layer or laminated paper and/or polymer film.

The laundry detergent and cleaning product tablets may be filled unsorted, i.e. as a loose heap, into a pouch made of said materials. On esthetic grounds and for the purpose of sorting the combinations into secondary packaging, however, it is preferred to fill the laundry detergent and cleaning product tablets individually, or sorted into groups of two or more, into bags or pouches. For individual application units of the laundry detergent and cleaning product tablets which are located in a bag or pouch, a term which has become established in the art is that of the “flow pack”. Flow packs of this kind may optionally then—again, preferably sorted—be packaged into outer packaging, which underscores the compact form of the tablet.

The single-layer or laminated paper or polymer film bags or pouches preferred for use as packaging systems may be designed in a very wide variety of ways: for example, as inflated pouches without a center seam or as pouches with a center seam which are sealed by means of heat, adhesives, or adhesive tapes. Single-layer pouch and bag materials include the known papers, which may if appropriate be impregnated, and also polymer films, which may if appropriate be coextruded. Polymer films that can be used as a packaging system in the context of the present invention are specified, for example, in Hans Domininghaus, “Die Kunststoffe und ihre Eigenschaften”, 3rd edition, VDI Verlag, Düsseldorf, 1988, page 193. FIG. 111 shown therein also gives indications of the water vapor permeability of the materials mentioned.

Combinations which are particularly preferred in the context of the present invention comprise as packaging system a bag or pouch of single-layer or laminated polymer film having a thickness of from 10 to 200 μm, preferably from 20 to 100 μm, and in particular from 25 to 50 μm.

Although it is possible in addition to the abovementioned films and papers to use wax-coated papers in the form of cartons as a packaging system for the laundry detergent and cleaning product tablets, it is preferred in the context of the present invention for the packaging system not to comprise any cardboard boxes made of wax-coated paper. In the context of the present invention, the term “packaging system” always relates to the primary packaging of the tablets, i.e., to the packaging whose inner face is in direct contact with the tablet surface. No requirements whatsoever are imposed on any optional secondary packaging, so that all customary materials and systems can be used in this case.

As already mentioned earlier on above, the laundry detergent and cleaning product tablets of the combination of the invention comprise further ingredients of laundry detergents and cleaning products, in varying amounts, depending on their intended use. Independently of the intended use of the tablets, it is preferred in accordance with the invention for the laundry detergent and cleaning product tablet(s) to have a relative equilibrium

humidity of less than 30% at 35° C. The relative equilibrium humidity of the laundry detergent and cleaning product tablets may be determined in accordance with common methods, the following procedure having been chosen in the context of the present investigations: a water-impermeable 1 liter vessel with a lid which has a closable opening for the introduction of samples was filled with a total of 300 g of laundry detergent and cleaning product tablets and held at a constant 23° C. for 24 h in order to ensure a uniform temperature of vessel and substance. The water vapor pressure in the space above the tablets can then be determined using a hygrometer (Hygrotest 6100, Testoterm Ltd., UK). The water vapor pressure is then measured every 10 minutes until two succeeding values show no deviation (equilibrium humidity). The abovementioned hygrometer permits direct display of the recorded values in % relative humidity. Likewise preferred are embodiments of the combination of the invention wherein the packaging system is of resealable configuration. Combinations wherein the packaging system has a microperforation may also be realized advantageously in accordance with the invention. packungssystem eine Microperforation aufweist, lassen sich erfindungsgemäβ mit Vorzug realisieren.

What is claimed is:

1. A process for producing multiphase laundry detergent or cleaning product tablets, comprising the steps of
a) producing core tablets comprising active substance,
b) optionally inserting one or more core tablets from step a) into a die of a tableting press,
c) filling at least one particulate premix into the die of the tableting press,
d) supplying at least one core tablet from step a) into the die of the tableting press,
e) optionally repeating steps c) and/or d) one or more times,
f) carrying out compression to give tablets, it being possible, if desired, to conduct steps c) and d) in the opposite order, wherein in at least one of process steps b), c), d) or f) the upper and/or lower punch of the tableting press has a nonplanar pressing face.

2. The process as claimed in claim 1, wherein the upper punch and/or lower punch of the tableting press does not have a nonplanar pressing face during the entire process.

3. The process as claimed in claim 2, wherein the punch used as upper and/or lower punch is constructed of a plurality of component punches which are movable independently of one another and parallel with respect to one another.

4. The process as claimed in either of claims 2 and 3, wherein the punch used as upper and/or lower punch is constructed of two component punches which are movable independently of one another and parallel with respect to one another, preference being given to punches comprising a central mandrel embraced by an annular punch.

5. The process as claimed in any of claims 2 to 4, wherein the pressing face of the lower punch in step b) has at least one cavity.

6. The process as claimed in any of claims 2 to 5, wherein the pressing face of the lower punch in step b) is planar.

7. The process as claimed in any of claims 2 to 6, wherein after each step c) the particulate premix(es) is(are) smoothed by lowering of the upper punch.

8. The process as claimed in claim 7, wherein the pressing face of the upper punch has at least one elevation when being lowered.

9. The process as claimed in any of claims 1 to 8, wherein the pressing face of the upper punch in step f) is planar.

10. The process as claimed in any of claims 1 to 9, wherein the pressing face of the upper punch is planar during the entire process.

11. The process as claimed in any of claims 1 to 9, wherein the pressing face of the upper punch has at least one elevation during the entire process.

12. A process for producing multiphase laundry detergent or cleaning product tablets, comprising the steps of
a) producing core tablets comprising active substance,
b) optionally inserting one or more core tablets from step a) into a die of a tableting press,
c) filling at least one particulate premix into the die of the tableting press,
d) optionally supplying one or more core tablets from step a) into the die of the tableting press,
e) optionally repeating steps b) and/or c) one or more times,
f) carrying out compression to give tablets having at least one cavity,
g) supplying core tablet(s) from step a) into the cavity/cavities of the tableting press,
h) pressing the core tablet(s) into the cavity/cavities.

13. The process as claimed in claim 12, wherein compression in step f) takes place using an upper punch whose embossing element has at least one stud surrounded by a planar base area.

14. The process as claimed in claim 13, wherein the base area of the embossing element in the pressing operation is flexible and the stud or studs is or are incompressible and at least adhesion-reducingly coated.

15. The process as claimed in claim 14, wherein the at least adhesion-reducing coating of the stud(s) comprises Ni-P-PTFE or C-diamond.

16. The process as claimed in any of claims 13 to 15, wherein the embossing element has a stud possessing a volume of from 0.5 to 5 ml, preferably from 0.6 to 3 ml, with particular preference from 0.8 to 2 ml.

17. The process as claimed in any of claims 13 to 16, wherein the embossing element has one or more studs each protruding at least 1 mm, preferably at least 2 mm, and in particular at least 3 mm from the base area.

18. The process as claimed in any of claims 13 to 17, wherein the base area of the embossing element is from 2.5 to 60 cm², preferably from 5 to 40 cm², with particular preference from 7.5 to 20 cm².

19. The process as claimed in any of claims 13 to 18, wherein the outer surface of the stud(s) forms an angle with respect to the base area of the embossing element of from 90 to 160°, preferably from 90 to 140°, and in particular from 100 to 120°.

20. The process as claimed in any of claims 13 to 19, wherein the pressing face of the stud(s) extends parallel to the base area of the embossing element.

21. The process as claimed in any of claims 12 to 20, wherein the core tablet(s) a) may be inserted positively into the cavity in step g).

22. The process as claimed in any of claims 12 to 21, wherein compression in step h) takes place at compressive pressures of from 0.1 to 50 kN cm⁻², preferably from 0.5 to 25 kN cm⁻², and in particular from 1 to 15 kN cm⁻².

23. The process as claimed in any of claims 1 to 22, wherein the mass of the core tablet a) is more than 0.5 g, preferably more than 1 g, and in particular more than 2 g.

24. The process as claimed in any of claims 1 to 23, wherein the core tablet a) has a base area of at least 50 mm², preferably of at least 100 mm², and in particular of at least 150 mm².

25. The process as claimed in any of claims 1 to 3, wherein the core tablet a) possesses a circular base area.

26. The process as claimed in any of claims 1 to 4, wherein the core tablet has a density of less than 1.4 g cm⁻³, preferably less than 1.2 g cm⁻³, and in particular less than 1.0 g cm⁻³.

27. The process as claimed in any of claims 1 to 5, wherein the mass of the overall laundry detergent or cleaning product tablet is from 10 to 100 g, preferably from 15 to 80 g, with particular preference from 18 to 60 g, and in particular from 20 to 45 g.

28. The process as claimed in any of claims 1 to 6, wherein the laundry detergent or cleaning product tablet has a base area of at least 500 mm², preferably of at least 750 mm², and in particular of at least 1000 mm².

29. The process as claimed in any of claims 1 to 7, wherein the overall tablet has a density of more than 1.1 g cm⁻³, preferably more than 1.2 g cm⁻³, and in particular more than 1.4 g cm⁻³.

30. The process as claimed in any of claims 1 to 8, wherein the particulate premix in step c) has a bulk density of at least 500 g/l, preferably at least 600 g/l, and in particular at least 700 g/l.

31. The process as claimed in any of claims 1 to 9, wherein the particulate premix in step c) has particle sizes of between 100 and 2000 μm, preferably between 200 and 1800 μm, with particular preference between 400 and 1600 μm, and in particular between 600 and 1400 μm.

32. The process as claimed in any of claims 1 to 10, wherein the compression in step a) and/or f) takes place at pressing pressures of from 1 to 100 kN cm⁻², preferably from 1.5 to 50 kN cm⁻², and in particular from 2 to 25 kN cm⁻².

33. The process as claimed in any of claims 1 to 11, wherein the core tablets are produced in step a) by casting.

34. The process as claimed in any of claims 1 to 11, wherein the core tablets are produced in step a) by sintering.

35. The process as claimed in any of claims 1 to 11, wherein the core tablets are produced in step a) by tableting.

36. The process as claimed in any of claims 1 to 11, wherein the core tablet is a capsule.

37. The process as claimed in any of claims 1 to 15, wherein the core tablet a) comprises surfactant ingredient(s).

38. The process as claimed in any of claims 1 to 16, wherein the core tablet a) comprises enzyme ingredient(s).

39. The process as claimed in any of claims 1 to 17, wherein the core tablet a) comprises bleach and/or bleach activator ingredient(s).

40. The process as claimed in any of claims 1 to 18, wherein the core tablet a) comprises disintegration aids and/or gas-forming systems as ingredients.

41. The process as claimed in any of claims 1 to 19, wherein the core tablet a) comprises water softeners and/or complexing agents as ingredients.

42. The process as claimed in any of claims 1 to 20, wherein production of the core tablets in step a) is followed by coating and/or encapsulation of the core tablets.

43. The process as claimed in any of claims 1 to 21, wherein the core tablet(s) produced in step a), based on its/their weight, comprises/comprise at least 30% by weight, preferably at least 37.5% by weight, and in particular at least 45% by weight, of meltable substance(s) having a melting point of more than 30° C.

44. The process as claimed in claim 22, wherein the core tablet(s) comprises/comprise one or more substances having a melting range between 30 and 100° C., preferably between 40 and 80° C., and in particular between 50 and 75° C.

45. The process as claimed in either of claims 22 and 23, wherein the core tablet(s) comprises/comprise at least one paraffin wax having a melting range from 30° C. to 65° C.

46. The process as claimed in any of claims 22 to 24, wherein the core tablets are produced by converting a melt into particulate material and subsequently compressing the particles.

47. The process as claimed in claim 25, wherein the core tablets a) are produced by flaking a melt and subsequently compressing the flakes.

48. The process as claimed in claim 25, wherein the core tablets a) are produced by pelletizing a melt and subsequently compressing the pellets.

49. The process as claimed in claim 25, wherein the core tablets a) are produced by prilling a melt and subsequently compressing the prills.

50. The process as claimed in any of claims 22 to 28, wherein core tablets a) are produced with air inclusions which possess not more than 0.8 times, preferably not more than 0.75 times, and in particular not more than 0.7 times, the mass of a melt body of equal volume and formulation.

51. The process as claimed in any of claims 22 to 28, wherein core tablets a) are produced without substantial air inclusions which possess at least 0.8 times, preferably at least 0.85 times, and in particular at least 0.9 times, the mass of a melt body of equal volume and formulation.

52. The process as claimed in any of claims 1 to 30, wherein at least one core tablet a) has the following composition:
i) from 10 to 89.9% by weight of surfactant(s),
ii) from 10 to 89.9% by weight of meltable substance(s) having a melting point of more than 30° C.,
iii) from 0.1 to 15% by weight of one or more solids,
iv) from 0 to 15% by weight of further active substances and/or auxiliaries.

53. The process as claimed in any of claims 1 to 30, wherein at least one core tablet a) has the following composition:
I) from 10 to 90% by weight of surfactant(s),
II) from 10 to 90% by weight of fatty substance(s),
III) from 0 to 70% by weight of meltable substance(s) having a melting point of more than 30° C.,
IV) from 0 to 15% by weight of further active substances and/or auxiliaries.

54. The process as claimed in either of claims 31 and 32, wherein the core tablet a) comprises as ingredient i) or I) from 15 to 80, preferably from 20 to 70, with particular preference from 25 to 60, and in particular from 30 to 50% by weight of surfactant(s).

55. The process as claimed in any of claims 31 to 33, wherein the core tablet a) comprises as ingredient ii) or III) from 15 to 85, preferably from 20 to 80, with particular preference from 25 to 75, and in particular from 30 to 70% by weight of meltable substance(s).

56. The process as claimed in claim 31 or either of claims 33 and 34, wherein the core tablet a) comprises the ingredient iii) in amounts of from 0.15 to 12.5, preferably from 0.2 to 10, with particular preference from 0.25 to 7.5, and in particular from 0.3 to 5% by weight.

57. The process as claimed in any of claims 31 to 35, wherein the core tablet a) comprises as ingredient i) or I) anionic and/or nonionic surfactant(s), preferably nonionic surfactant(s).

58. The process as claimed in any of claims 31 to 36, wherein the core tablet a) comprises as ingredient i) or I) nonionic surfactant(s) having a melting point of more than 20° C., preferably more than 25° C., with particular preference between 25 and 60° C., and in particular between 26.6 and 43.3° C.

59. The process as claimed in any of claims 31 to 37, wherein the core tablet a) comprises as ingredient i) or I) ethoxylated nonionic surfactant(s) obtained from C₆₋₂₀ monohydroxyalkanols or C₆₋₂₀ alkylphenols or C₁₆₋₂₀ fatty alcohols and more than 12 mol, preferably more than 15 mol, and in 10 particular more than 20 mol, of ethylene oxide per mole of alcohol.

60. The process as claimed in any of claims 31 to 38, wherein the core tablet a) comprises as ingredient i) or I) ethoxylated and propoxylated nonionic surfactants in which the propylene oxide units in the molecule account for up to 25% by weight, preferably up to 20% by weight, and in particular up to 15% by weight, of the overall molecular mass of the nonionic surfactant.

61. The process as claimed in any of claims 31 to 39, wherein the core tablet a) comprises as ingredient i) or I) nonionic surfactants of the formula
R¹O[CH₂CH(CH₃)O]ₓ[CH₂CH₂O]_{y}[CH₂CH(OH)R2]
in which R¹ is a linear or branched aliphatic hydrocarbon radical having 4 to 18 carbon atoms, or mixtures thereof, R² is a linear or branched hydrocarbon radical having 2 to 26 carbon atoms, or mixtures thereof, x is between 0.5 and 1.5, and y is at least 15.

62. The process as claimed in any of claims 31 to 39, wherein the core tablet a) comprises as ingredient i) or I) endgroup-capped poly(oxyalkylated) nonionic surfactants of the formula
R¹O[CH₂CH(R³)O]ₓ[CH₂]ₖCH(OH)[CH₂]ⱼOR²
in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is between 1 and 30, k and j are between 1 and 12, preferably between 1 and 5, particular preference being given to surfactants of the type
R¹O[CH₂CH(R³)O]ₓCH₂CH(OH)CH₂OR²
in which x is from 1 to 30, preferably from 1 to 20, and in particular from 6 to 18.

63. The process as claimed in any of claims 32 to 41, wherein the core tablet a) comprises as ingredient II) from 12.5 to 85, preferably from 15 to 80, with particular preference from 17.5 to 75, and in particular from 20 to 70% by weight of fatty substance(s).

64. The process as claimed in any of claims 32 to 42, wherein the core tablet a) comprises as ingredient II) one or more substances from the groups of the fatty alcohols, fatty acids, and fatty acid esters.

65. The process as claimed in any of claims 32 to 43, wherein the core tablet a) comprises as ingredient II) one or more C₁₀₋₃₀ fatty alcohols, preferably C₁₂₋₂₄ fatty alcohols, with particular preference 1-hexadecanol, 1-octadecanol, 9-cis-octadecen-1-ol, all-cis-9,12-octadecadien-1-ol, all-cis-9,12,15-octadecatrien-1-ol, 1-docosanol, and mixtures thereof.

66. The process as claimed in any of claims 31 to 44, wherein the core tablet a) comprises as ingredient ii) or III) one or more substances having a melting range between 30 and 100° C., preferably between 40 and 80° C., and in particular between 50 and 75° C.

67. The process as claimed in any of claims 31 to 45, wherein the core tablet a) comprises as ingredient ii) or III) at least one paraffin wax having a melting range of from 30° C. to 65° C.

68. The process as claimed in any of claims 31 to 46, wherein the core tablet a) comprises as ingredient ii) or III) at least one substance from the group consisting of polyethylene glycols (PEGs) and/or polypropylene glycols (PPGs).

69. The process as claimed in any of claims 31 to 47, wherein the core tablet a) comprises as ingredient iv) or IV) further active substances and/or auxiliaries from the groups of dyes, fragrances, antisettling agents, suspension agents, antifloating agents, thixotropic agents and dispersing auxiliaries in amounts of from 0 to 10% by weight, preferably from 0.25 to 7.5% by weight, with particular preference from 0.5 to 5% by weight, and in particular from 0.75 to 2.5% by weight.

70. The process as claimed in any of claims 31 to 48, wherein the core tablet a) has a melting point of between 50 and 80° C., preferably between 52.5 and 75° C., and in particular between 55 and 65° C.

71. The process as claimed in any of claims 1 to 49, wherein the weight ratio of overall tablet to the sum of the masses of all core tablets present in the tablet is in the range from 1:1 to 100:1, preferably from 2:1 to 80:1, with particular preference from 3:1 to 50:1, and in particular from 4:1 to 30:1.

72. The process as claimed in any of claims 1 to 71, wherein the sum of all visible surfaces of all core tablets present in the tablet makes up from 1 to 80%, preferably from 5 to 65%, with particular preference from 10 to 50%, and in particular from 15 to 40%, of the overall surface area of the tablet.

73. The process as claimed in any of claims 1 to 72, wherein the volume of all core tablets present in the tablet makes from 1 to 60%, preferably from 2.5 to 50%, with particular preference from 5 to 40%, and in particular from 7.5 to 30%, of the overall volume of the tablet.

74. The process as claimed in any of claims 1 to 73, wherein the height of the tablets produced in step a) makes up from 10 to 50%, preferably from 15 to 45%, with particular preference from 20 to 40%, and in particular from 25 to 35%, of the overall height of the tablet.

75. The process as claimed in any of claims 1 to 51, wherein at least one core tablet dissolves more rapidly than the base tablet.

76. The process as claimed in any of claims 1 to 52, wherein at least one core tablet dissolves more slowly than the base tablet.
